(19) United States
(12) Patent Application Publication
(10) Pub. No.: US 2004/0210466 A1
(43) Pub. Date: Oct. 21, 2004

(54) Skill determination method, skill determination system, skill determination server, skill determination client and skill determination evaluation board

(75) Inventors: Tetsuya Hasebe, Tokyo (JP); Takashi Mita, Yokohama-shi (JP); Masaaki Sakata, Yokohama-shi (JP)

Correspondence Address: PILLSBURY WINTHROP, LLP, P.O. BOX 10500, MCLEAN, VA, 22102, US

(73) Assignee: Tokyo Electron Device Limited, Yokohama-shi (JP)

(21) Appl. No.: 10/826,911

(22) Filed: Apr. 19, 2004

(30) Foreign Application Priority Data
Apr. 21, 2003 (JP) 2003-116022

(51) Int. Cl. G06F 17/60

(52) U.S. Cl. 705/7

(57) ABSTRACT

A skill determination method, a skill determination system, a skill determination server, a skill determination client and a skill determination evaluation board are disclosed for objectively determine one or more skills of a user as a design engineer without use of much time and cost. The skill determination method includes steps of: supplying a question file to determine one or more skills of a user from a skill determination server to a skill determination client; providing one or more answers to the question file to the skill determination client through input manipulation of the user and supplying an answer file corresponding to the answers from the skill determination client to the skill determination server; and evaluating knowledge of the user based on a comparison result between the answer file and a correct answer file corresponding to the question file and determining the skills of the user by using the skill determination server.

### BACKGROUND OF THE INVENTION

1. Field of the Invention

The present invention relates to a skill determination method, a skill determination system, a skill determination server, a skill determination client and a skill determination evaluation board. More particularly, the present invention relates to a skill determination method, a skill determination system, a skill determination server, a skill determination client and a skill determination evaluation board for determining one or more skills of a user in terms of design techniques.

2. Description of the Related Art

For example, when companies recruit employees, many of the companies determine whether to accept an applicant based on his or her resume submitted by the applicant, an interview result and an aptitude test result.

In recruitment for a design engineer required to have sophisticated skills such as a circuit design skill for semiconductors, if the acceptance determination is made based on only the resume submitted by an applicant, the interview result and the aptitude test result, there is a risk that design techniques of the applicant, which are simply referred to as “skills” hereinafter, may be evaluated depending on subjectivity of a recruitment staff. In order to determine such skills of an applicant objectively, many companies have conventionally conducted a practical examination by providing applicants with some assignments related to circuit design of semiconductors.

In such a case, however, it is necessary to reserve an examination place to carry out the practical examination and gather together examiners and applicants in the examination place. In particular, recruitment for foreigners is highly expensive. As the Internet has been widely used in recent years, there is an increasing demand to develop a system that can objectively determine skills of an applicant by using the Internet.

For example, Japanese Laid-Open Patent Application No. 2002-040926 discloses an Internet learning and testing technique. Also, Japanese Laid-Open Patent Applications No. 2002-244547, No. 2002-297016 and No. 2002-304487 disclose techniques to provide services such as an Internet learning service.

In order to determine skills of an applicant by providing the applicant with questions to evaluate a sophisticated technique such as circuit design of semiconductors, it is necessary to objectively determine skills of the applicant based on questions correctly answered by the applicant. However, it is highly difficult to make such objective determination properly.

### SUMMARY OF THE INVENTION

It is a general object of the present invention to provide a skill determination method, a skill determination system, a skill determination server, a skill determination client and a skill determination evaluation board in which one or more of the above-mentioned problems are eliminated.

A more specific object of the present invention is to provide a skill determination method, a skill determination system, a skill determination server, a skill determination client and a skill determination evaluation board that can objectively determine skills of users in terms of design techniques easily.

In order to achieve the above-mentioned objects, there is provided according to one aspect of the present invention a method of determining one or more skills of a user as a design engineer by using a skill determination server and a skill determination client wherein the skill determination client is operated by the user and is connected to the skill determination server via a network, including steps of: supplying a question file to determine the one or more skills of the user from the skill determination server to the skill determination client; providing one or more answers to the question file to the skill determination client through input manipulation of the user and supplying an answer file corresponding to the one or more answers from the skill determination client to the skill determination server; and evaluating knowledge of the user based on a comparison result between the answer file and a correct answer file corresponding to the question file and determining the one or more skills of the user as a design engineer by using the skill determination server.

Additionally, there is provided according to another aspect of the present invention a method of determining one or more skills of a user as a design engineer by using a skill determination server, a skill determination client and a skill determination evaluation board wherein the skill determination client is operated by the user and is connected to the skill determination server via a network, and the skill determination evaluation board is connected to the skill determination client via an interface, including steps of: supplying a question file to determine the one or more skills of the user from the skill determination server to the skill determination client; providing one or more answers to the question file to the skill determination client through input manipulation of the user and supplying an answer file corresponding to the one or more answers from the skill determination client to the skill determination evaluation board; configuring a circuit corresponding to the answer file on an actual element by using the skill determination evaluation board; supplying an input signal to conduct logic verification on the circuit from the skill determination server to the skill determination evaluation board and supplying an answer output signal generated from the circuit in response to inputting of the input signal in the circuit from the skill determination evaluation board to the skill determination server; and evaluating knowledge of the user based on a comparison between a correct answer output signal to be output in response to inputting of the input signal in the circuit and the supplied answer output signal and determining the one or more skills of the user as a design engineer by using the skill determination server.

Additionally, there is provided according to another aspect of the present invention a method of determining one or more skills of a user as a design engineer by using a skill determination server, a skill determination client and a skill determination evaluation board wherein the skill determination client is operated by the user and is connected to the skill determination server via a network, and the skill determination evaluation board is connected to the skill determination client via an interface, including steps of: supplying a question file to determine the one or more skills of the user from the skill determination server to the skill determination client; providing one or more answers to the question file to the skill determination client through input manipulation of the user and supplying an answer file corresponding to the one or more answers from the skill determination client to the skill determination evaluation board; configuring a circuit corresponding to the answer file on an actual element by using the skill determination evaluation board; supplying an input signal to conduct logic verification on the circuit and a correct answer output signal to be output in response to inputting of the input signal in the circuit from the skill determination server to the skill determination evaluation board and supplying a comparison result between the correct answer output signal to be output in response to inputting of the input signal in the circuit and an answer output signal generated from the circuit from the skill determination evaluation board to the skill determination server; and evaluating knowledge of the user based on the comparison result supplied from the skill determination evaluation board and determining the one or more skills of the user as a design engineer by using the skill determination server.

Additionally, there is provided according to another aspect of the present invention a skill determination system for determining one or more skills of a user, including: a skill determination server; and a skill determination client being connected to the skill determination server via a network, wherein the skill determination client, in response to receipt of a question file to determine the one or more skills of the user as a design engineer from the skill determination server and one or more answers to the question file from the user, supplies an answer file corresponding to the one or more answers to the skill determination server; and the skill determination server, in response to receipt of the answer file from the skill determination client, evaluates knowledge of the user based on a comparison result between the answer file and a correct answer file corresponding to the question file and determines the one or more skills of the user as a design engineer.

Additionally, there is provided according to another aspect of the present invention a skill determination system for determining one or more skills of a user, including: a skill determination server; a skill determination client being connected to the skill determination server via a network; and a skill determination evaluation board being connected to the skill determination client via an interface, wherein the skill determination client, in response to receipt of a question file to determine the one or more skills of the user as a design engineer from the skill determination server and one or more answers to the question file from the user, supplies an answer file corresponding to the one or more answers to the skill determination evaluation board; the skill determination evaluation board, in response to receipt of the answer file from the skill determination client, configures a circuit corresponding to the answer file on an actual element, and in response to receipt of an input signal to conduct logic verification on the circuit from the skill determination server, supplies an answer output signal generated from the circuit in response to inputting of the input signal in the circuit to the skill determination server; and the skill determination server, in response to receipt of the answer output signal from the skill determination evaluation board, evaluates knowledge of the user based on a comparison result between the supplied answer output signal and a correct answer output signal to be output in response to inputting of the input signal in the circuit and determines the one or more skills of the user as a design engineer.

Additionally, there is provided according to another aspect of the present invention a skill determination system for determining one or more skills of a user, including: a skill determination server; a skill determination client being connected to the skill determination server via a network; and a skill determination evaluation board being connected to the skill determination client via an interface, wherein the skill determination client, in response to receipt of a question file to determine the one or more skills of the user as a design engineer from the skill determination server and one or more answers to the question file from the user, supplies an answer file corresponding to the one or more answers to the skill determination evaluation board; the skill determination evaluation board, in response to receipt of the answer file from the skill determination client, configures a circuit corresponding to the answer file on an actual element, and in response to receipt of an input signal to conduct logic verification on the circuit and a correct answer output signal to be output in response to inputting of the input signal in the circuit from the skill determination server, supplies a comparison result between the correct answer output signal and an answer output signal generated from the circuit to the skill determination server; and the skill determination server, in response to receipt of the comparison result from the skill determination evaluation board, evaluates knowledge of the user based on the supplied comparison result and determines the one or more skills of the user as a design engineer.

According to one aspect of the present invention, since knowledge of a user can be evaluated based on a comparison result between an answer file and a correct answer file corresponding to a question file and one or more skills of the user can be determined, it is possible to objectively determine the skills of the user as a design engineer without use of much time and cost.

Other objects, features and advantages of the present invention will become more apparent from the following detailed description when read in conjunction with the accompanying drawings.

### BRIEF DESCRIPTION OF THE DRAWINGS

FIG. 1 is a block diagram illustrating an exemplary functional structure of a skill determination system according to a first embodiment of the present invention;

FIG. 2 is a block diagram illustrating an exemplary hardware configuration of a skill determination client and a skill determination server according to the first embodiment;

FIG. 3 is a sequence diagram of an exemplary operation of the skill determination system according to the first embodiment;

FIG. 4 is a diagram illustrating a portion of an exemplary source code of an assignment according to the first embodiment;

FIG. 5 is a diagram illustrating another portion of the exemplary source code of the assignment according to the first embodiment;

FIG. 6 is a diagram illustrating another portion of the exemplary source code of the assignment according to the first embodiment;

FIG. 7 is a diagram illustrating another portion of the exemplary source code of the assignment according to the first embodiment;

FIG. 8 is a partial flowchart of an exemplary skill determination operation according to the first embodiment;

FIG. 9 is a partial flowchart of the exemplary skill determination operation according to the first embodiment;

FIG. 10 shows an exemplary score table according to the first embodiment;

FIGS. 11A and 11B show exemplary passing score table and score file, respectively, according to the first embodiment;

FIG. 12 is a block diagram illustrating an exemplary functional structure of a skill determination system according to a second embodiment of the present invention;

FIG. 13 is a sequence diagram of an exemplary operation of a skill determination system according to the second embodiment;

FIG. 14 is a partial flowchart of an exemplary skill determination operation according to the second embodiment;

FIG. 15 is a partial flowchart of the exemplary skill determination operation according to the second embodiment;

FIG. 16 shows exemplary input signals, a correct answer output signal, and an answer output signal according to the second embodiment;

FIG. 17 is a diagram to explain an exemplary comparison result between an answer test pattern and a correct answer test pattern shown in FIG. 16;

FIG. 18 shows an exemplary score table according to the second embodiment;

FIGS. 19A and 19B show exemplary passing score table and score file, respectively, according to the second embodiment;

FIG. 20 is a block diagram illustrating an exemplary functional structure of a skill determination system according to a third embodiment of the present invention;

FIG. 21 is a block diagram illustrating an exemplary structure of a skill determination evaluation board according to the third embodiment;

FIG. 22 is a sequence diagram of an exemplary operation of a skill determination system according to the third embodiment; and

FIG. 23 shows another exemplary structure of a skill determination evaluation board according to the third embodiment.

### DETAILED DESCRIPTION OF THE PREFERRED EMBODIMENTS

Reference will now be made in detail to the preferred embodiments of the invention, examples of which are illustrated in the accompanying drawings. Wherever possible, the same reference numbers are used in the drawings and the description to refer to the same or like parts.

The following embodiments are described by using examples in which it is determined whether an applicant understands a hardware description language as an exemplary skill regarding design techniques when a recruitment staff makes a decision to hire the applicant.

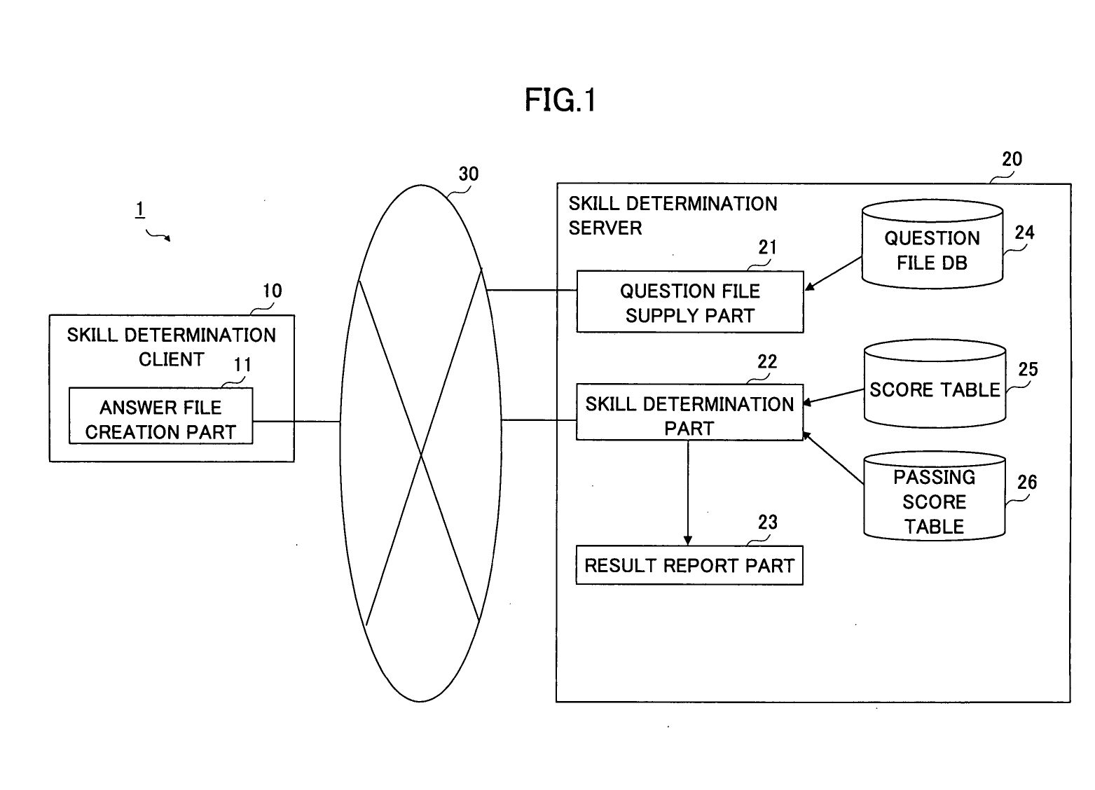

A description is given, with reference of FIG. 1, of an exemplary functional structure of a skill determination system according to a first embodiment of the present invention.

FIG. 1 is a block diagram illustrating an exemplary functional structure of a skill determination system according to the first embodiment.

Referring to FIG. 1, a skill determination system 1 includes a skill determination client 10 and a skill determination server 20. The skill determination client 10 and the skill determination server 20 are connected to each other via a network 30 such as the Internet and WAN (Wide Area Network). Although the skill determination system 1 may include other components, components unnecessary for explaining this embodiment are omitted in the illustration.

The skill determination client 10, which is operated by an applicant, comprises an answer file creation part 11. On the other hand, the skill determination server 20, which is used by a recruitment staff, comprises a question file supply part 21, a skill determination part 22, a result report part 23, a question file database (DB) 24, a score table 25 and a passing score table 26.

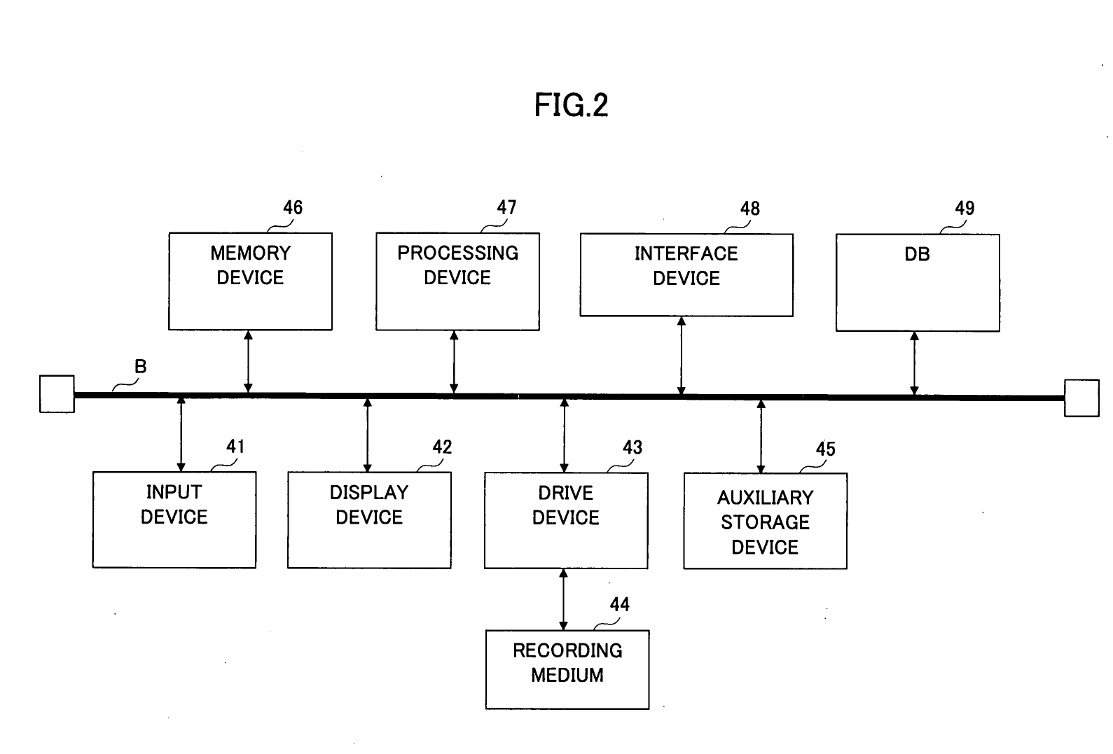

A description is given, with reference to FIG. 2, of an exemplary hardware configuration of a skill determination client and a skill determination server according to the first embodiment.

FIG. 2 is a block diagram illustrating an exemplary hardware configuration of a skill determination client and a skill determination server according to the first embodiment.

Referring to FIG. 2, the skill determination client 10 or the skill determination server 20 comprises an input device 41, a display device 42, a drive device 43, a recording medium 44, an auxiliary storage device 45, a memory device 46, a processing device 47, an interface device 48 and DB 49, and these hardware components are connected to each other via a bus B.

The input device 41, which comprises a keyboard and a mouse, is used to input operational instructions. The display device 42 displays various windows and data necessary for operations. The interface device 48, which comprises a modem, a router and the like, is an interface to connect to the network 30. DB 49 manages a variety of information items necessary for operations of the skill determination client 10 or the skill determination server 20.

A skill determination server program for controlling the skill determination server 20 is provided via a recording medium 44 such as CD-ROM (Compact Disk-Read Only Memory). The recording medium 44 having the skill determination server program is set in the drive device 43, and the skill determination server program is installed from the recording medium 44 to the auxiliary storage device 45 via the drive device 43.

On the other hand, a sill determination client program for controlling the skill determination client 10 is provided via a recording medium 44 such as CD-ROM. The recording medium 44 having the skill determination client program is set in the drive device 43, and the skill determination client program is installed from the recording medium 44 to the auxiliary storage device 45 via the drive device 43.

It is noted that the recording medium 44 may be configured from a recording medium for optically, electrically or magnetically recording information such as CD-ROM, a flexible disk and a magneto optical disk (MO), a semiconductor memory for electrically recording information such as ROM (Read Only Memory) and a flash memory, and any other types of recording media.

The skill determination server program or the skill determination client program also includes other programs stored in recording media of other computers connected via the interface device 48. Such a skill determination server program or a skill determination client program stored in a recording medium of another computer is downloaded via the interface device 48 and installed in the auxiliary storage device 45.

The auxiliary storage device 45 stores an installed skill determination server program or an installed skill determination client program as well as files and data required to execute the skill determination server program or the skill determination client program. The memory device 46 stores the skill determination server program or the skill determination client program read from the auxiliary storage device 45 at start time of the skill determination server 20 or the skill determination client 10.

The processing device 47 implements functions of the skill determination client 10 or the skill determination server 20, which are described in detail below, in accordance with the skill determination client program or the skill determination server program in the memory device 46.

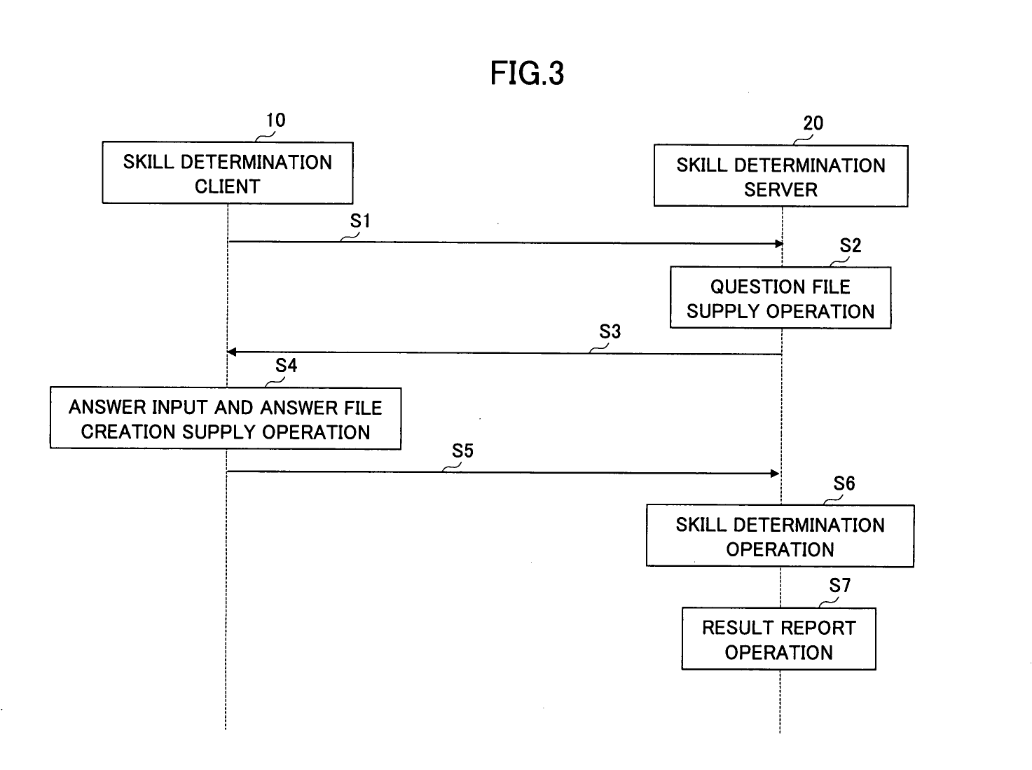

A description is given, with reference to FIG. 3, of an exemplary skill determination operation of a skill determination system 1 according to the first embodiment.

FIG. 3 is a sequence diagram of an exemplary skill determination operation of the skill determination system 1 shown in FIG. 1.

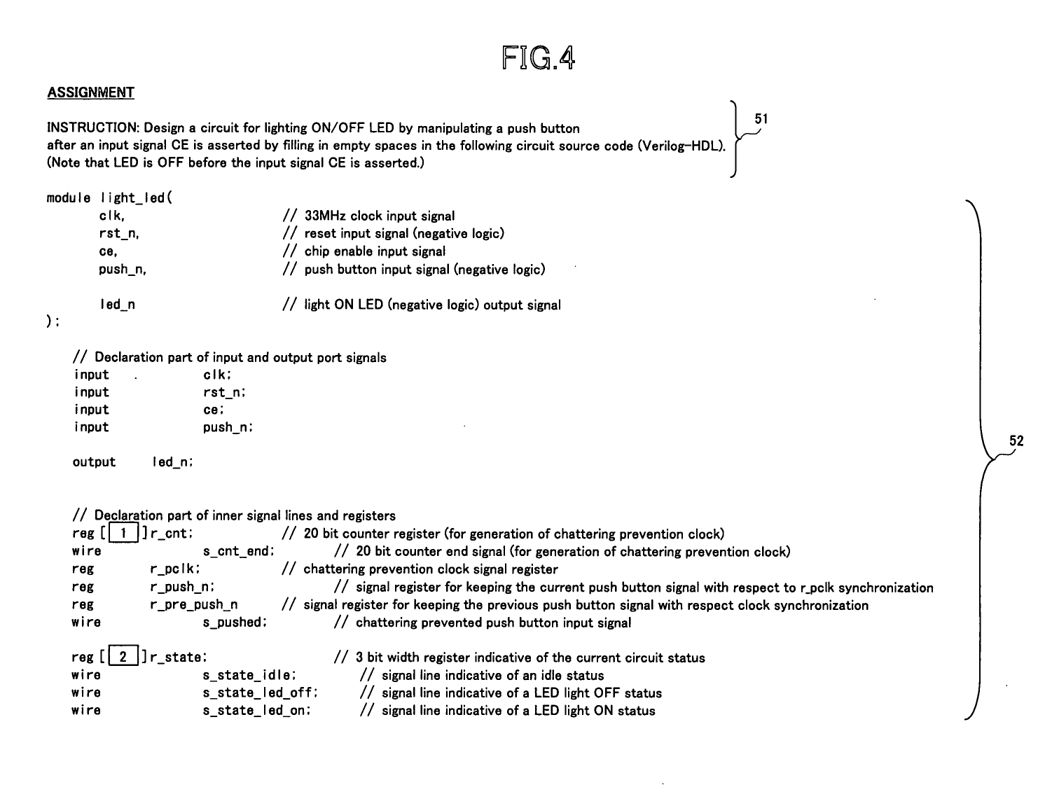

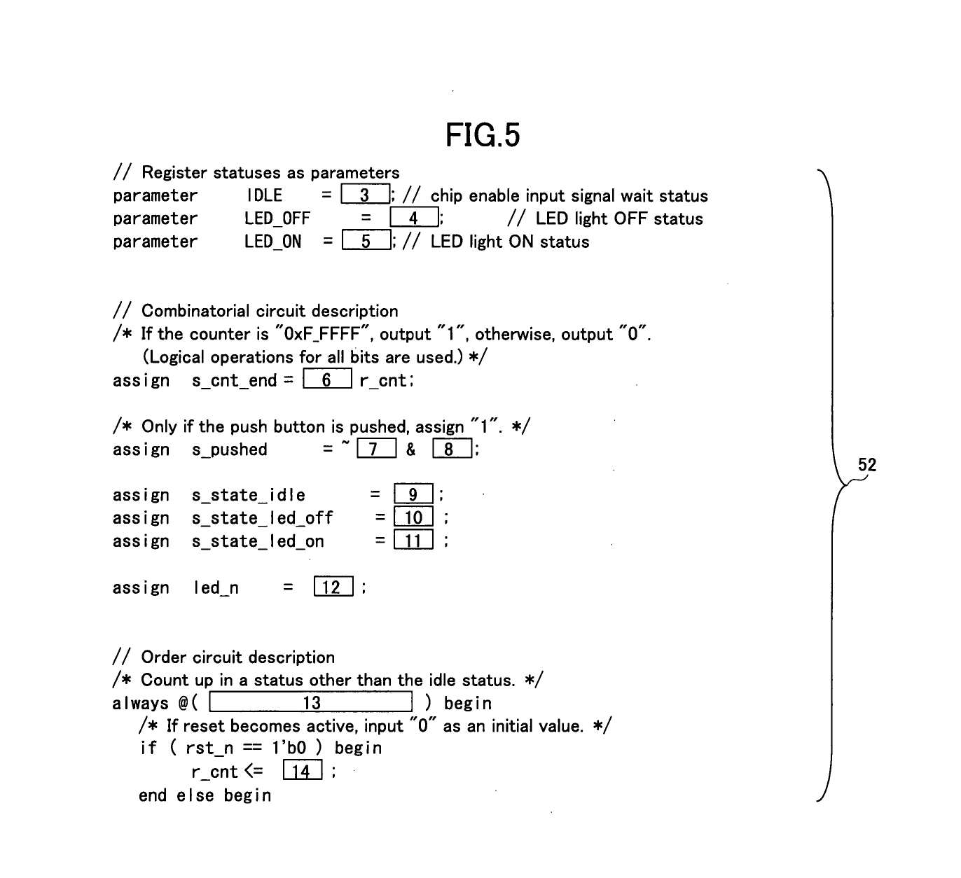

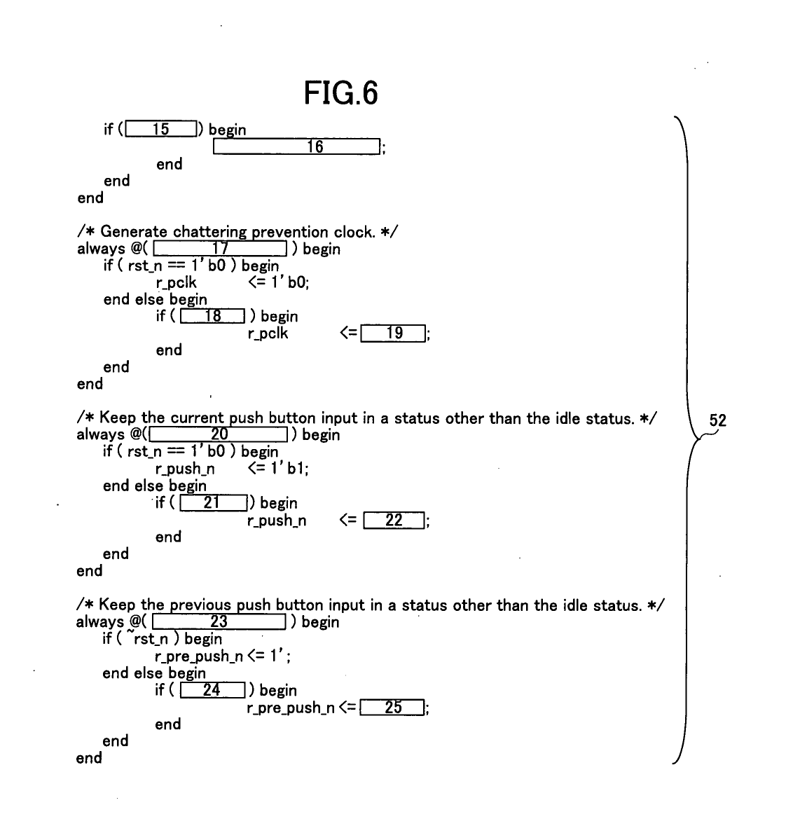

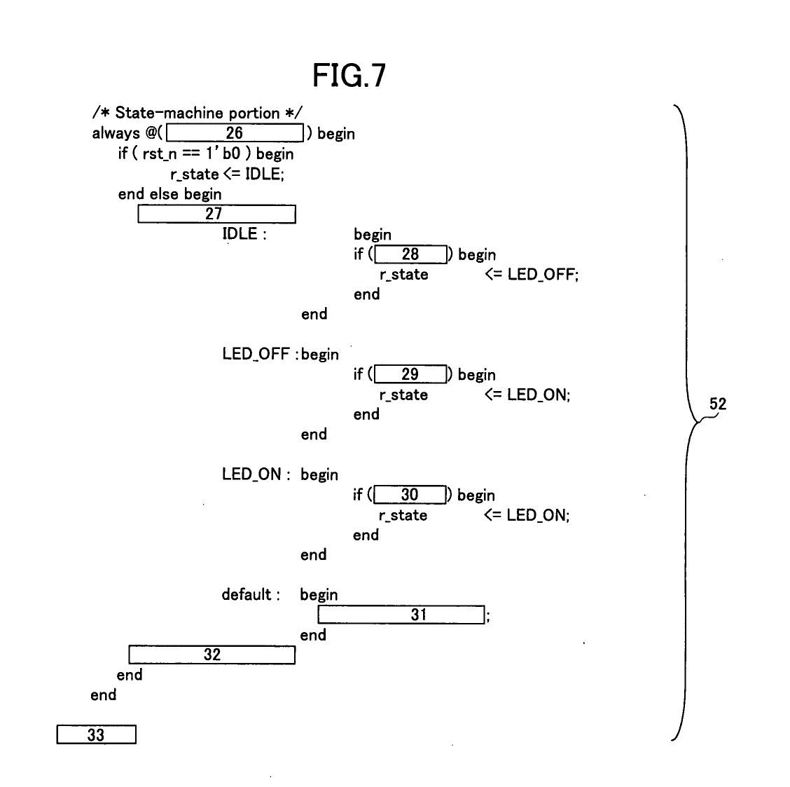

Referring to FIG. 3, the answer file creation part 11 of the skill determination client 10 requests the question file supply part 21 of the skill determination server 20 to send a circuit design specification and an assigned source code as a question file at step S1. At step S2, the question file supply part 21 of the skill determination server 20 reads a circuit design specification and an assigned source code, as illustrated in FIG. 4 through FIG. 7, from the question file DB 24.

FIG. 4 through FIG. 7 are diagrams illustrating an exemplary assigned source code.

Referring to FIG. 4 through FIG. 7, an assigned source code comprises an explanation portion 51 to explain a given assignment and a list portion 52 to represent a circuit corresponding to a given circuit design specification in accordance with a hardware description language Verilog-HDL. It will be observed that the list portion 52 includes empty spaces.

These empty spaces in the list portion 52 are provided for an applicant to input one of a syntax pair, which is used in the form of a pair in accordance with grammatical rules of the hardware description language (if-statement, case-statement, for-statement, while-statement or the like), or a logic statement that an applicant can answer with reference to the given circuit design specification.

In other words, the empty spaces are provided in the assigned source list corresponding to individual rules such as a hardware description language syntax rule, a logic description rule, a concurrent process rule, a sequential process rule, and a function description rule.

At step S3, the question file supply part 21 of the skill determination server 20 sends the circuit design specification and the assigned source code to the answer file creation part 11 of the skill determination client 10.

Here, the skill determination client 10 may use a browser to access the circuit design specification and the assigned source code. In this case, the skill determination client 10 does not have to include the answer file creation part 11.

At step S4, the answer file creation part 11 of the skill determination client 10, in response to a request from the applicant, displays the received circuit design specification and the assigned source code on the display device 42. Here, the answer file creation part 11 may print the circuit design specification and the assigned source code corresponding to a request from the applicant.

In order to complete the assigned source code represented in accordance with the hardware description language corresponding to the circuit design specification, the applicant inputs answers in the empty spaces in the assigned source code with reference to the circuit design specification. It is noted that the applicant inputs the answers in the empty spaces in the assigned source code by operating the skill determination client 10.

Then, the answer file creation part 11 of the skill determination client 10 creates an answer file based on the completed source code.

At step S5, the answer file creation part 11 sends the answer file to the skill determination part 22 of the skill determination server 20.

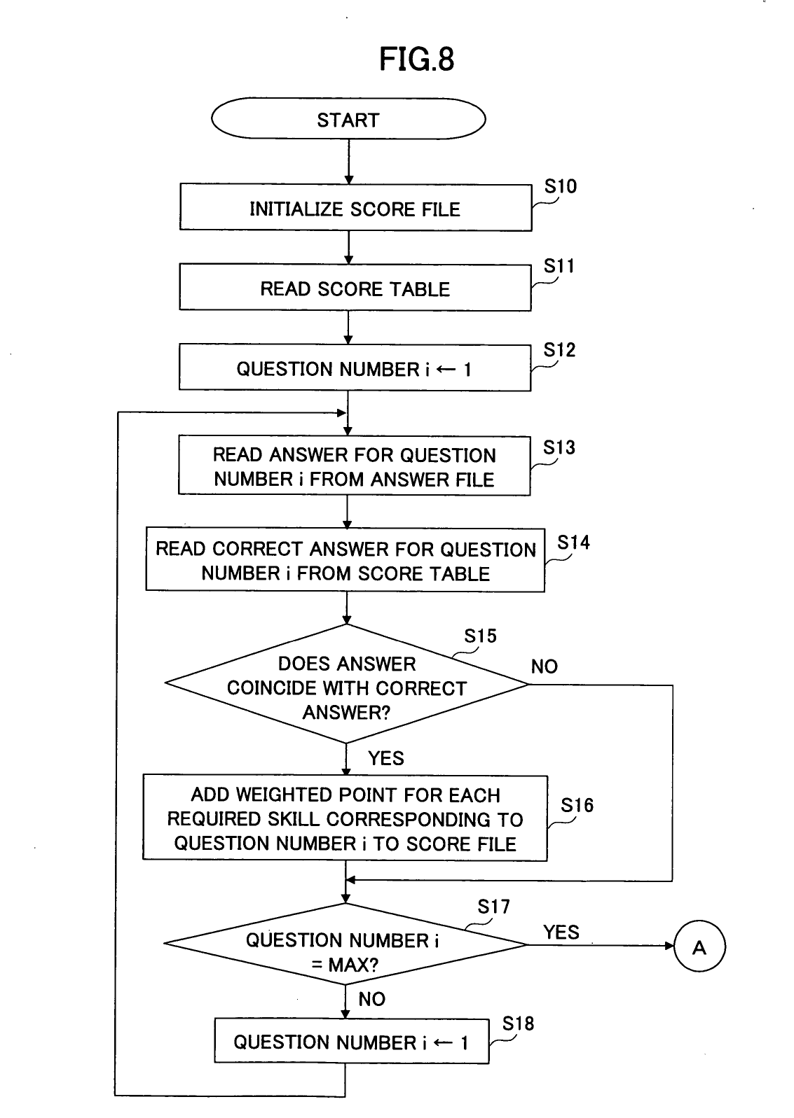

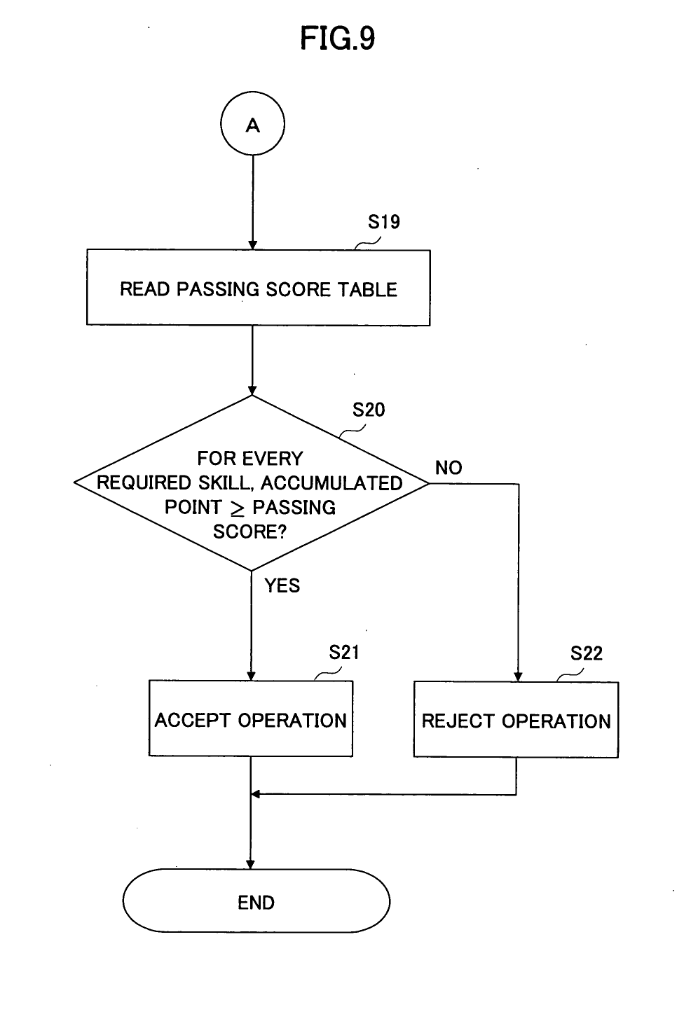

At step S6, the skill determination part 22 of the skill determination server 20 uses the received answer file and a score table stored in the store table 25 to perform a skill determination operation as illustrated in FIG. 8 and FIG. 9.

FIG. 8 and FIG. 9 are a flowchart of an exemplary skill determination operation according to the first embodiment.

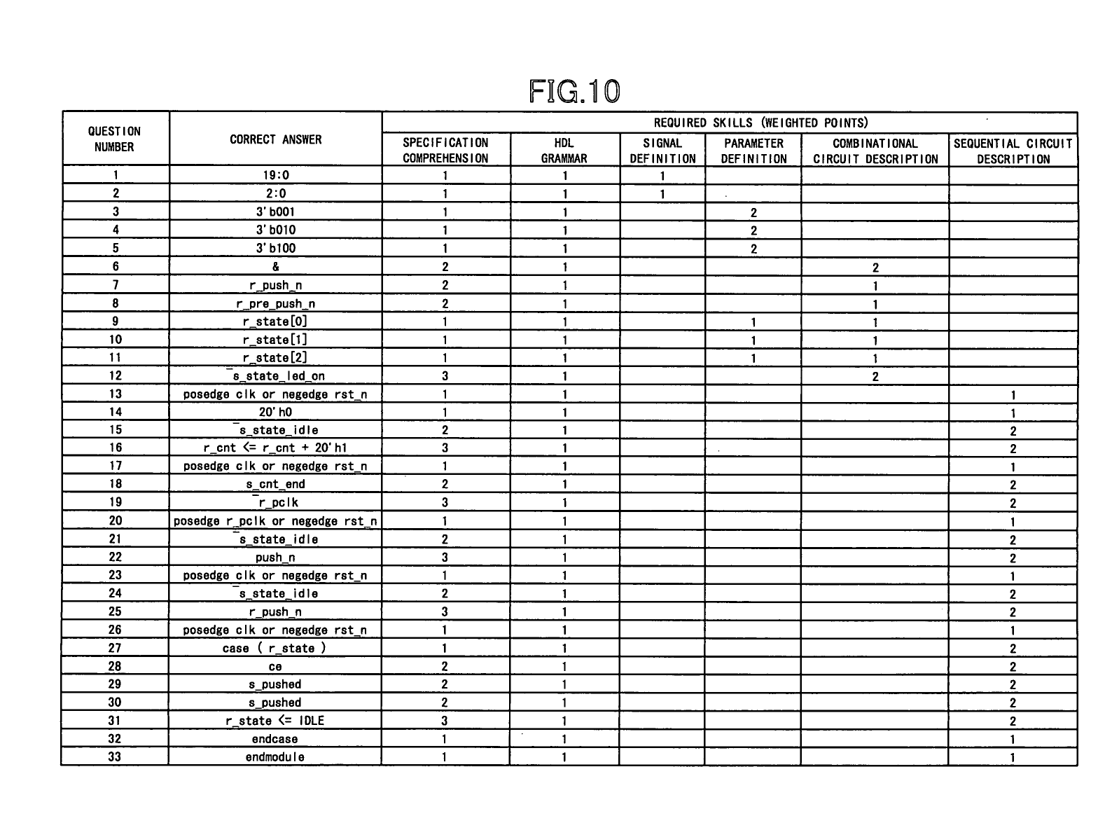

Referring to FIG. 8 and FIG. 9, the skill determination part 22 initializes a score file, which is described in detail below, by setting all scores as Os at step S10. At step S11, the skill determination part 22 reads a score table corresponding to the received answer file from the score table 25. The read score table has a structure, for example, as illustrated in FIG. 10.

FIG. 10 shows an exemplary score table according to the first embodiment.

Referring to FIG. 10, the illustrated score table comprises data items: “question number”, “correct answer” and “weighted points of required skills”.

The individual question numbers are associated with identification numbers to identify empty spaces in the assigned source code. In the data item “correct answer”, contents to be correctly filled in the empty spaces are represented in accordance with the hardware description language corresponding to a circuit expected from a circuit design specification.

Also, the data item “weighted points of required skills” represents points to be added to a score file for correct answering of each skill, such as hardware description language syntax rules, logic description rules, concurrent process rules, sequential process rules and function description rules, required to input the correct answer in the empty space. In the score table shown in FIG. 10, specification comprehension, hardware description language (HDL) grammar, signal definition, parameter definition, combinational circuit description, and sequential circuit description are provided as skills required to input correct answers in empty spaces.

Referring back to FIG. 8, the skill determination part 22 sets the question number i as “1” at step S12. At step S13, the skill determination part 22 reads an answer input for the question number i by the applicant from the answer file. At step S14, the skill determination part 22 extracts a correct answer of the question number i from the read score table.

At step S15, the skill determination part 22 determines whether the answer read at step S13 and the correct answer read at step S14 are the same at step S15. If the skill determination part 22 determines that the answer and the correct answer are the same (S15: YES), the skill determination part 22 proceeds to step S16.

At step S16, the skill determination part 22 extracts a required skill weighted point corresponding to the question number i from the score table, and adds the weighted point to the score file. Then, the skill determination part 22 proceeds to step S17. On the other hand, if the skill determination part 22 determines that the answer and the correct answer are not the same (S15: NO), the skill determination part 22 proceeds to step S17.

At step S17, the skill determination part 22 determines whether the question number i is the maximum question number (MAX). In other words, the skill determination part 22 determines whether all answers have been read from the answer file.

If the skill determination part 22 determines that the question number i is not the maximum question number (S17: NO), the skill determination part 22 proceeds to step S18. At step S18, the skill determination part 22 increments the question number i by one, and returns to step S13. In other words, the skill determination part 22 repeats steps S13 through S18 until the question number i reaches the maximum question number.

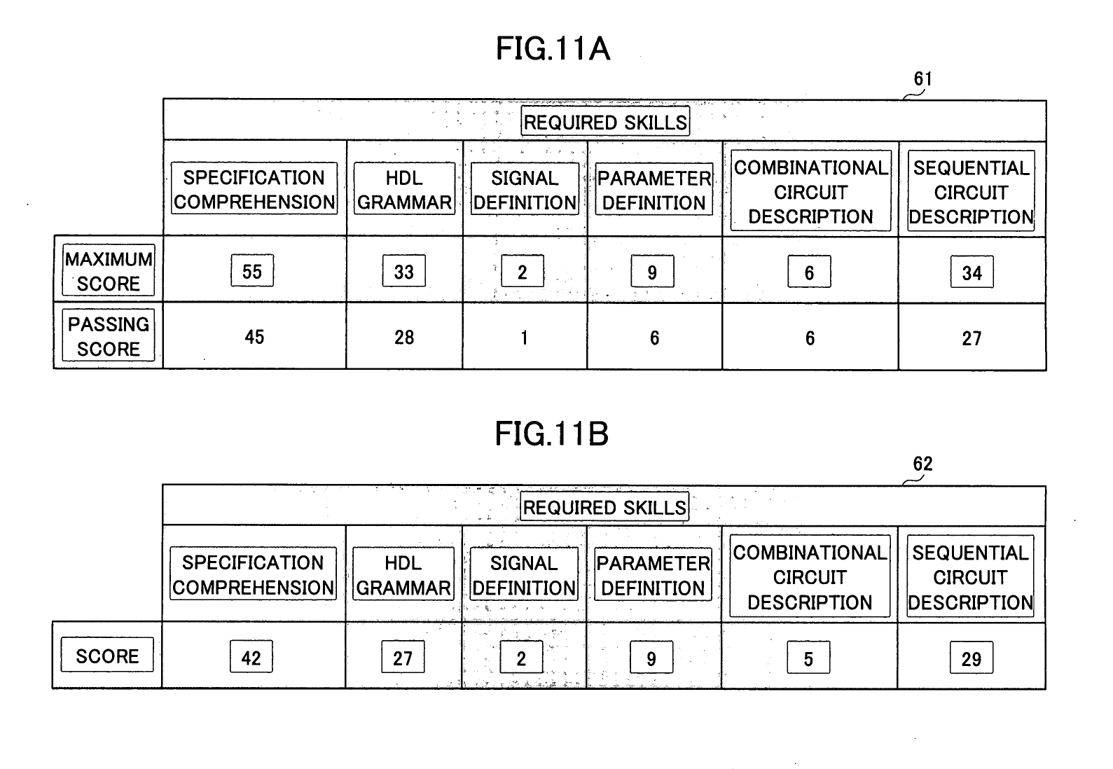

On the other hand, if the skill determination part 22 determines that the question number i is the maximum question number (S17: YES), the skill determination part 22 proceeds to step S19 in FIG. 9. At step S19, the skill determination part 22 reads a passing score table, as illustrated in FIG. 11, from the passing score table 26.

FIGS. 11A and 11B show exemplary passing score table and score file according to the first embodiment.

Referring to FIGS. 11A and 11B, a passing score table 61 represents maximum scores and passing scores for individual required skills possessed by the applicant to input correct answers in empty spaces in the assigned source code. Also, a score file 62 represents scores obtained by accumulating weighted points for individual required skills during step S16. In FIG. 11B, the illustrated score file 62 corresponds to the case where the applicant has provided incorrect answers for the question numbers 6 through 8, 20, 25 and 31.

At step S20, the skill determination part 22 compares a passing score of the passing score table 61 with a corresponding score of the score file 62 for each required skill, and determines whether all scores of the required skills are greater than or equal to the corresponding passing scores.

If the skill determination part 22 determines that all the scores of the required skills are greater than or equal to the corresponding passing scores (S20: YES), the skill determination part 22 proceeds to step S21 to perform an acceptance operation. At step S21, for example, the skill determination part 22 informs a result report part 23 that the applicant has successfully completed the assignment.

On the other hand, if the skill determination part 22 determines that all the scores of the required skills are not greater than or equal to the corresponding passing scores (S20: NO), the skill determination part 22 proceeds to step S22 to perform a rejection operation. At step S22, for example, the skill determination part 22 reports one or more required skills below the passing scores to the result report part 23.

Referring back to FIG. 3, the result report part 23 performs a result report operation to report the result to the recruitment staff and the applicant at step S7. The result report part 23 informs the recruitment staff that the applicant is successful or unsuccessful. In addition, if the applicant is unsuccessful, the result report part 23 reports one or more required skills below the passing scores to the recruitment staff. In another embodiment of the present invention, the result report part 23 may further report the result to the applicant via an e-mail. Alternatively, the result report part 23 may allow the applicant to check the result by using a Web page.

According to the skill determination system 1 of the first embodiment, it is possible to evaluate and determine skills of an applicant required as a design engineer based on comparison between answers input in empty spaces in an assigned source code by the applicant and correct answers read from a score table.

Specifically, the score table associates the individual empty spaces in the assigned source code with skills required to be correctly answered for the empty spaces. As a result, it is possible to objectively and easily determine whether the applicant has skills required as a design engineer with less use of time and cost.

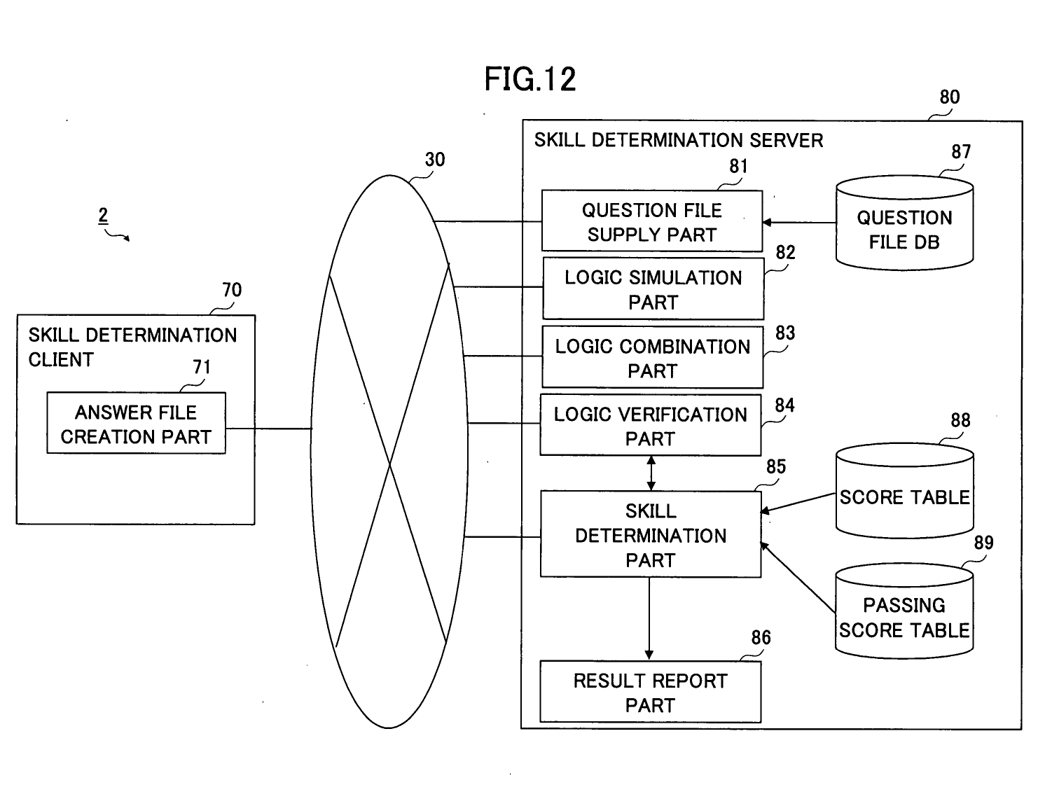

A description is given, with reference to FIG. 12, of an exemplary functional structure of a skill determination system according to a second embodiment of the present invention.

FIG. 12 is a block diagram illustrating an exemplary functional structure of a skill determination system according to the second embodiment. A skill determination system 2 according to the second embodiment has a structure partially similar to that of the skill determination system 1 according to the first embodiment, and the description thereof is omitted. Also, components unnecessary for explaining the second embodiment are omitted in FIG. 12.

Referring to FIG. 12, the skill determination system 2 comprises a skill determination client 70 and a skill determination server 80. In the skill determination system 2, the skill determination client 70 and the skill determination server 80 are connected to each other via a network 30 such as the Internet and WAN.

The skill determination client 70, which is operated by an applicant, comprises an answer file creation part 71 described in detail below. On the other hand, the skill determination server 80, which is used by a recruitment staff, comprises a question file supply part 81, a logic simulation part 82, a logic combination part 83, a logic verification part 84, a skill determination part 85, a result report part 86, a question file DB 87, a score table 88 and a passing score table 89.

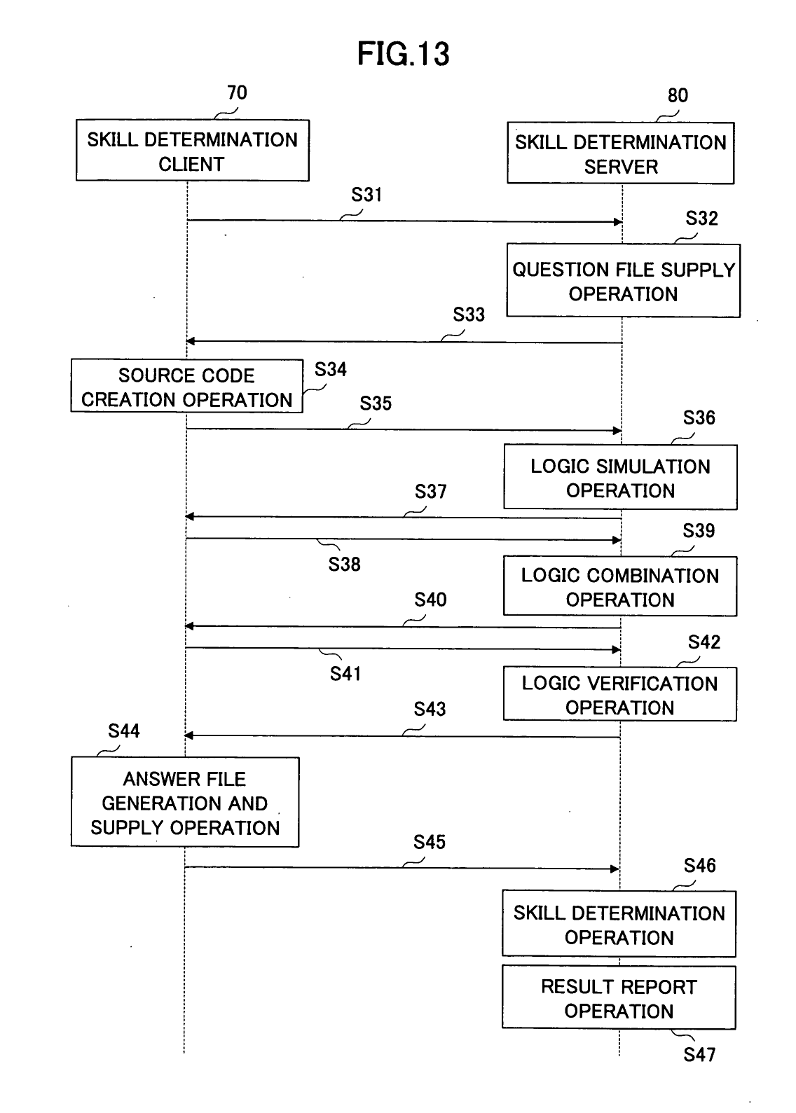

A description is given, with reference to FIG. 13, of an exemplary operation of the skill determination system 2 according to the second embodiment.

FIG. 13 is a sequence diagram of an exemplary operation of the skill determination system 2 according to the second embodiment.

Referring to FIG. 13, the answer file creation part 71 of the skill determination client 70 requests the question file supply part 81 of the skill determination server 80 to send a circuit design specification, a design convention and a combination condition as a question file at step S31. It is noted that if an applicant is required to create the design convention and the combination condition, the question file does not include the design convention and the combination condition. At step S32, the question file supply part 81 of the skill determination server 80 reads the circuit design specification, the design convention and the combination condition from the question file DB 87.

At step S33, the question file supply part 81 sends the circuit design specification, the design convention and the combination condition to the answer file creation part 71 of the skill determination client 70. Here, the skill determination client 70 may use a browser to access the circuit design specification, the design convention and the combination condition. In this case, the skill determination client 70 does not have to include the answer file creation part 71.

At step S34, the answer file creation part 71 of the skill determination client 70, in response to a request from the applicant, displays the circuit design specification, the design convention and the combination condition on the display device 42. Here, the answer file creation part 71, in response to a request from the applicant, may print the circuit design specification, the design convention and the combination condition.

With reference to the circuit design specification, the applicant creates a source code representing a circuit corresponding to the received circuit design specification in a hardware description language. It is noted that the applicant can create the source code by manipulating the skill determination client 70.

At step S35, the answer file creation part 71 of the skill determination client 70, in response to an applicant's request, supplies the source code to the logic simulation part 82 of the skill determination server 80 to perform logic simulation on the source code. At step S36, the logic simulation part 82 conducts the logic simulation on the received source code.

At step S37, the logic simulation part 82 supplies a result of the logic simulation to the answer file creation part 71 of the skill determination client 70. Here, the answer file creation part 71 of the skill determination client 70 displays the received result of the logic simulation on the display device 42.

The applicant repeats steps S34 through S37 until the simulation result meets the circuit design specification. Here, the applicant determines whether the simulation result matches the circuit design specification.

At step S38, the answer file creation part 71 of the skill determination client 70, in response to a request from the applicant, supplies the source code to the logic combination part 83 of the skill determination server 80 to perform logic combination on the source code corresponding to the design convention and the combination condition. At step S39, the logic combination part 83 conducts the logic combination on the source code corresponding to the design convention and the combination condition, and thereby creates a netlist. At step S40, the logic simulation part 82 supplies the created netlist to the answer file creation part 71 of the skill determination client 70.

At step S41, the answer file creation part 71 of the skill determination client 70, in response to a request from the applicant, supplies the netlist to the logic verification part 84 of the skill determination server 80 to perform logic verification. At step S42, the logic verification part 84 conducts the logic verification on the received netlist.

At step S43, the logic verification part 84 supplies a result of the logic verification to the answer file creation part 71 of the skill determination client 70. Here, the answer file creation part 71 of the skill determination client 70 displays the received verification result on the display device 42.

In the logic verification described herein, it is checked whether the verification result meets the circuit design specification. Also, it is analyzed whether the designed wire layout can be physically stored. In addition, timings of input and output signals are analyzed. Here, in the storage feasibility analysis, the wire layout process is conducted from the netlist based on pin arrangement, libraries and input and output signals, and it is determined whether the created netlist can be stored in an element designated in the circuit design specification based on the analysis result of the physical storage feasibility. Also, in the analysis of function timings, function timings are analyzed by using the netlist, the libraries and the design convention, and it is verified whether the timing of an output signal is appropriate for an input signal.

The applicant repeats steps S34 through S43 until the verification result matches the circuit design specification, the design convention and the combination condition. It is noted that the applicant determines whether the verification result matches the circuit design specification, the design convention and the combination condition.

At step S44, the answer file creation part 71 of the skill determination client 70, in response to a request from the applicant, creates an answer file including at least the netlist. At step S45, the answer file creation part 71 sends the created answer file to the skill determination part 85 of the skill determination server 80.

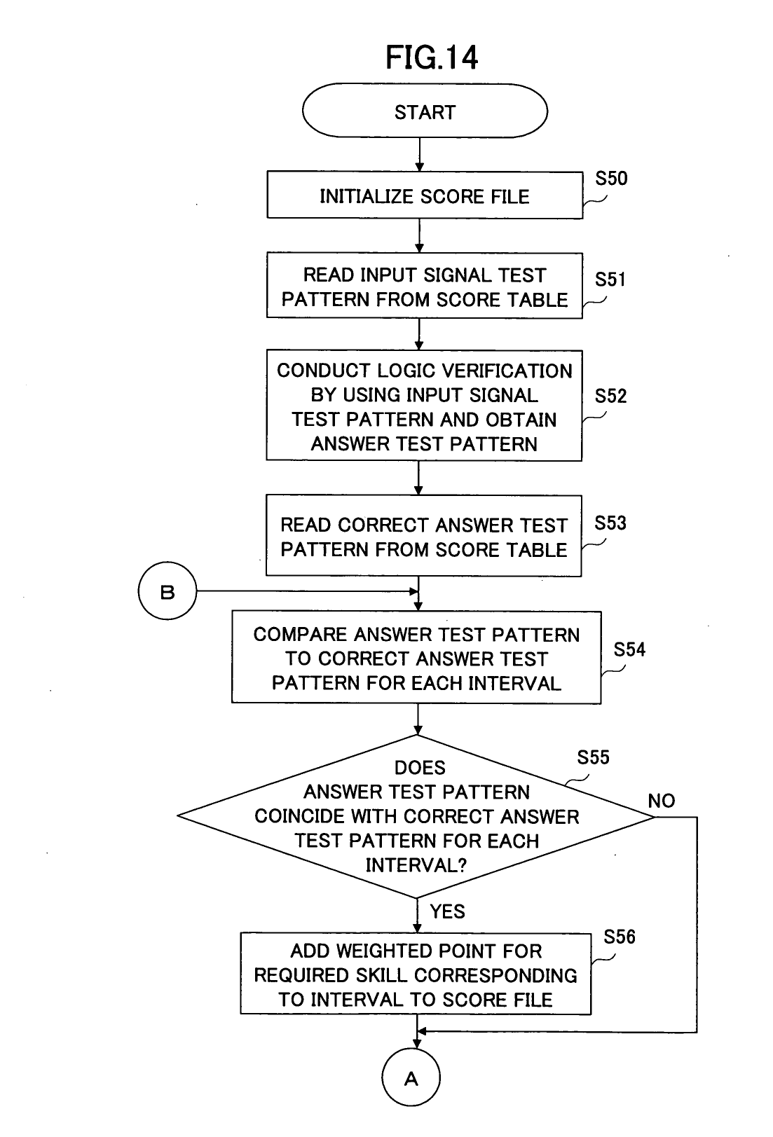

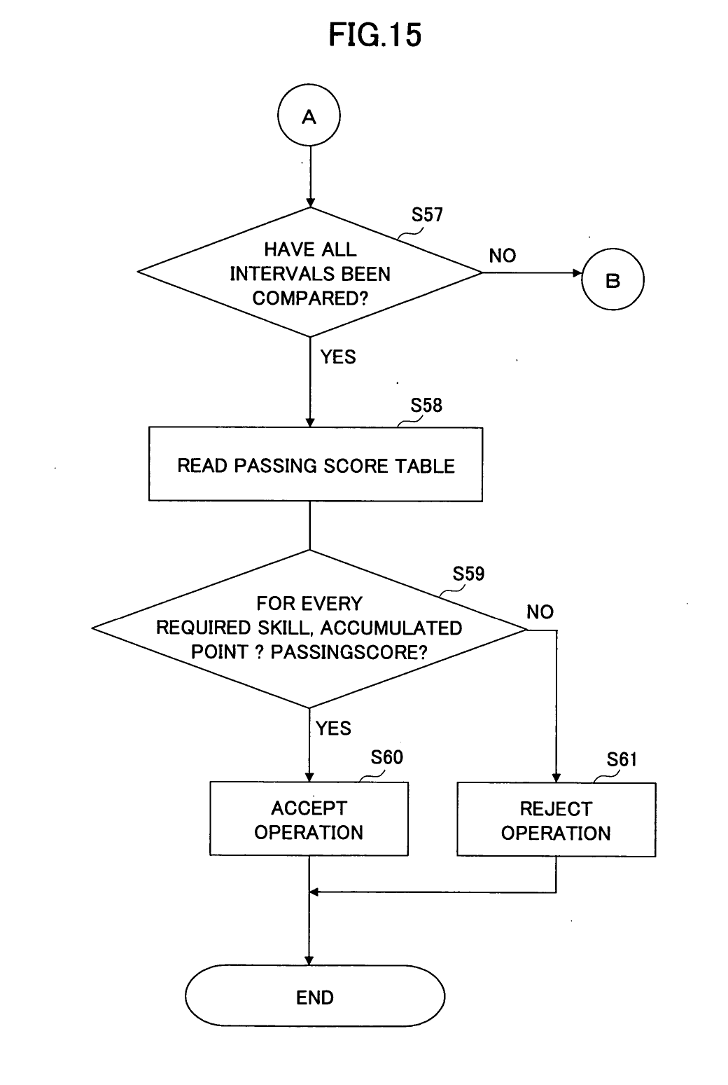

At step S46, the skill determination part 85 of the skill determination server 20 uses the received answer file and a score table in the score table DB 88 to perform skill determination as illustrated in FIG. 14 and FIG. 15.

FIG. 14 and FIG. 15 are a flowchart of an exemplary skill determination operation according to the second embodiment.

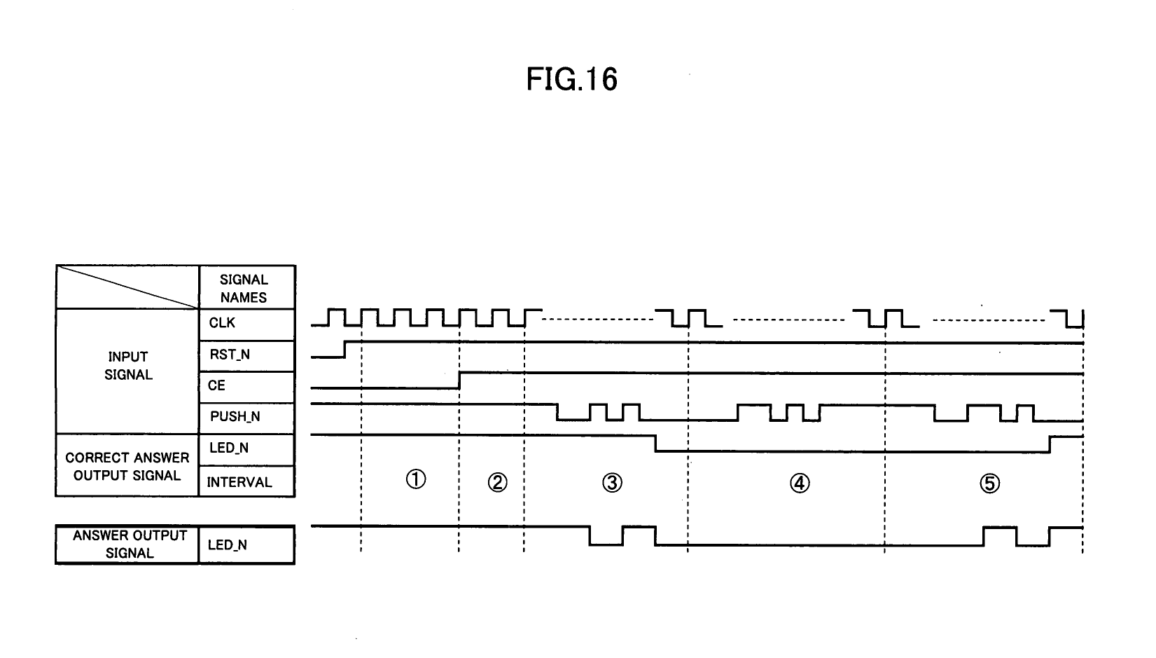

Referring to FIG. 14 and FIG. 15, a score file is initialized, and all scores of the score file are set as Os at step S50. At step S51, the skill determination part 85 reads a test pattern of input signals, which is referred to as an input test pattern hereinafter, corresponding to the answer file from the score table 88. The input test pattern read from the score table 88 is configured as illustrated in FIG. 16.

FIG. 16 shows exemplary input signals, a correct answer output signal, and an answer output signal according to the second embodiment.

The input test pattern and a test pattern of the correct answer output signal, which is referred to as a correct answer test pattern hereinafter, are stored in the score table 88 in advance corresponding to a circuit design specification, a design convention and a combination condition. Also, a test pattern of the answer output signal, which is referred to as an answer test pattern hereinafter, is obtained in a way described in detail below.

At step S52, the skill determination part 85 supplies a netlist included in the answer file received at step S45 and the input test pattern read at step S51 to the logic verification part 84 to request logic verification. The logic verification part 84 uses the supplied netlist and input test pattern to conduct the logic verification, and obtains an answer test pattern. The logic verification part 84 supplies the obtained answer test pattern to the skill determination part 85.

At step S53, the skill determination part 85 reads a correct answer test pattern corresponding to the answer file from the score table 88. At step S54, the skill determination part 85 compares the answer test pattern to the correct answer test pattern for each predefined interval (for example, for each of intervals \mathring{1} through \mathring{5} in FIG. 16).

It is noted that a comparison method between the answer test pattern and the correct answer test pattern is set in advance for each predefined interval. For example, in the intervals \mathring{1} and \mathring{2}, NOR of the answer test pattern and the correct answer test pattern is taken for each clock, and the computed NOR values are summed. Also, in the intervals \mathring{3} through \mathring{5}, start and end values of waveforms of the answer test pattern and the correct answer test pattern are obtained. Furthermore, in the intervals \mathring{3} through \mathring{5}, the numbers of waveform change points, for example, the numbers of switch times between 0 and 1, of the answer test pattern are obtained.

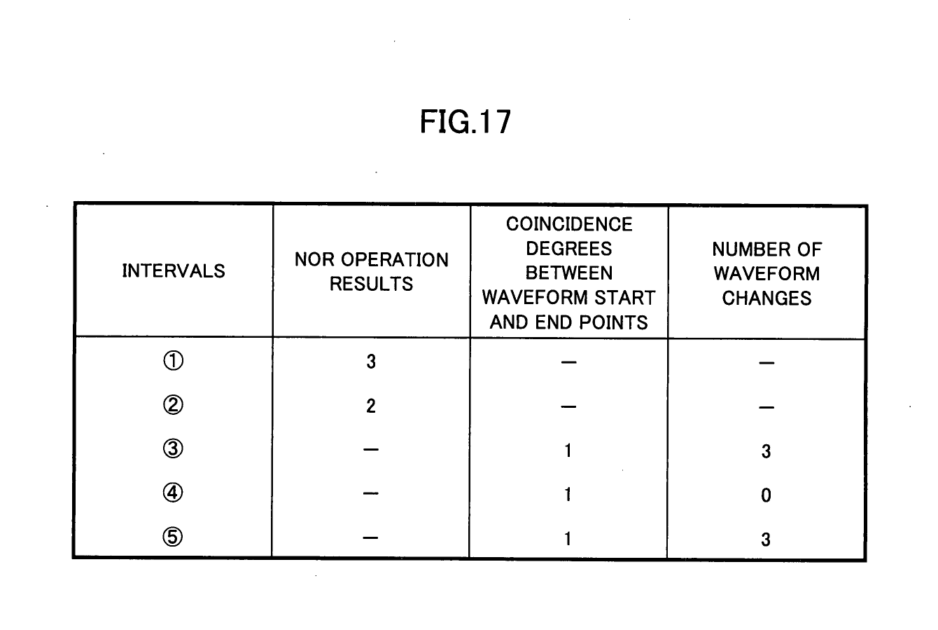

For example, if the answer test pattern is compared to the correct answer test pattern in FIG. 16, the skill determination part 85 obtains a comparison result as illustrated in FIG. 17.

FIG. 17 is a diagram to explain an exemplary comparison result between the answer test pattern and the correct answer test pattern shown in FIG. 16.

Referring to FIG. 17, a comparison result includes data items such as “intervals”, “NOR operation results”, “coincidence degrees of waveform start and end points” and “the numbers of waveform changes”.

An NOR operation result is a total value of NOR values, which are obtained by taking NOR of the answer test pattern and the correct answer test pattern for each clock. In the illustration, the data item “NOR operation results”, for example, represent that summed NOR values of the intervals \mathring{1} and \mathring{2} are 3 and 2, respectively.

A coincidence degree of waveform start and end points indicates whether values of start and end points of the waveform of the answer test pattern coincide with values of start and end points of the waveform of the correct answer test pattern for each of the intervals \mathring{3} through \mathring{5}. If an interval of the intervals \mathring{3} through \mathring{5} has the correspondence degree of 1, the values of the start and end points of the waveform of the answer test pattern coincide with the values of the start and end points of the waveform of the correct answer test pattern in the interval.

The number of waveform changes is the number of change points of the waveform of the answer test pattern for each of the intervals \mathring{3} through \mathring{5}. In the illustration, it is represented that the numbers of change points of the intervals \mathring{3} through \mathring{5} are 3, 0 and 3, respectively.

At step S55, the skill determination part 86 obtains a coincidence condition from the score table 88 for each predefined interval, and determines whether the comparison result obtained at step S54 coincides with the coincidence condition. It is noted that the coincidence condition is set in advance.

For example, for the intervals \mathring{1} and \mathring{2}, the skill determination part 85 determines that the comparison result coincides with the coincidence conditions if the totals of values obtained by the NOR operation are 3 and 2 in the intervals \mathring{1} and \mathring{2}, respectively. Also, for the intervals \mathring{3} through \mathring{5}, the skill determination part 85 determines that the comparison result coincides with the coincidence conditions if values of start and end points of the waveform of the answer test pattern coincide with values of start and end points of the waveform of the correct answer test pattern.

In addition, for the intervals \mathring{3} and \mathring{5}, the skill determination part 85 determines that the comparison result coincides with the coincidence condition if the numbers of change points of the waveform in the intervals \mathring{3} and \mathring{5} are less than or equal to 3, respectively. Also, for the interval \mathring{4}, the skill determination part 85 determines that the comparison result coincides with the coincidence condition if the number of change points in the interval \mathring{4} is equal to 0.

If the skill determination part 85 determines that the comparison result coincides with the coincidence condition for each predefined interval (S55: YES), the skill determination part proceeds to step S56. At step S56, the skill determination part 85 reads a score table indicative of weighted points for individual required skills corresponding to the predefined interval from the score table 88. Then, the skill determination part 85 accumulates the weighted points of the interval in the score file, and proceeds to step S57. On the other hand, if the skill determination part 85 determines that the comparison result does not coincide with the coincidence condition for each predefined interval (S55: No), the skill determination part 85 proceeds to step S57.

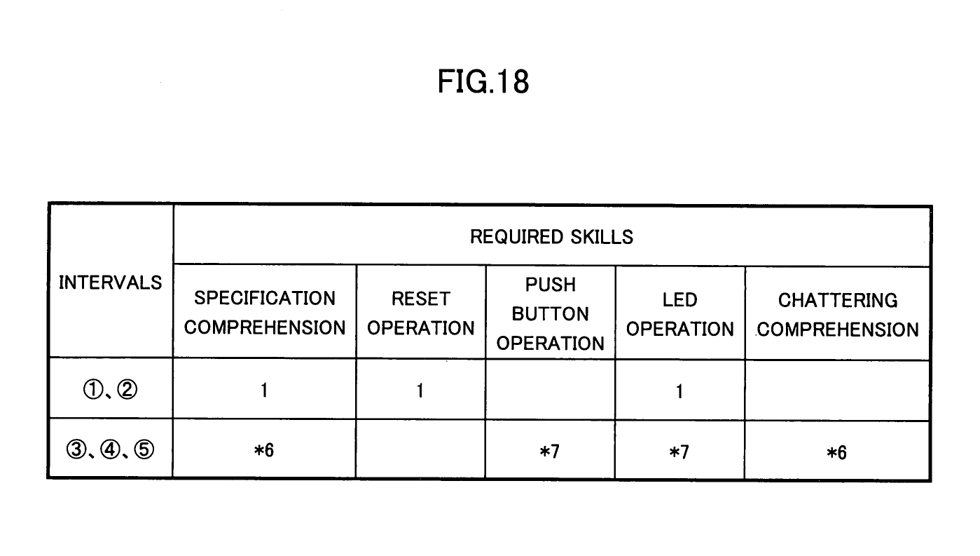

FIG. 18 shows an exemplary score table according to the second embodiment.

Referring to FIG. 18, the score table includes data items such as “intervals” and “weighted points of required skills”. The data item “weighted points of required skills” represents information to add a point to a score file, if the intervals \mathring{1} through \mathring{5} satisfy the coincidence conditions, for each knowledge item (for example, specification comprehension, reset operation, push button operation, LED operation and chattering comprehension) required to make an answer test pattern coincide with the coincidence conditions of the intervals \mathring{1} through \mathring{5}.

For example, if the totals of NOR values in the intervals \mathring{1} and \mathring{2} are 3 and 2, respectively, the skill determination part 85 adds the weighted point of 1 for a required skill (for example, specification comprehension, reset operation and LED operation) to the score file.

Also, if values of waveform start and end points of the answer test pattern does not coincide with values of waveform start and end points of the correct answer test pattern for each of the intervals \mathring{3} through \mathring{5}, the skill determination part 85 adds no weighted point to the score file for each required skill regardless of the number of change points of the waveform of the answer test pattern.

Furthermore, for the intervals \mathring{3} and \mathring{5}, if the number of waveform change points is greater than or equal to 5, the skill determination part 85 adds no weighted point in the score file for each required skill. Also, if the number of waveform change points is equal to 3, the skill determination part 85 adds the weighted point of 1 to the score file for a required skill (for example, specification comprehension, push button operation, LED operation and chattering comprehension). Also, if the number of waveform change points is equal to 1, the skill determination part 85 adds the weighted point of 2 to the score file for a required skill.

It is noted that the number of waveform change points must be equal to 0 for the interval \mathring{4}. In the score table shown in FIG. 18, the notation “*6” represents addition of a doubled weighted point of the intervals \mathring{3} through \mathring{5} to the score file. Also, the notation “*7” represents that the weighted point of 1 should be added to the score file if the total of weighted points of the intervals \mathring{3} through \mathring{5} is greater than or equal to 1.

At step S57, the skill determination part 85 determines whether all predefined intervals have been compared. If it is determined that all the predefined intervals have been compared (S57: YES), the skill determination part 85 proceeds to step S58. If it is determined that all the predefined intervals have not been compared (S57: NO), the skill determination part 85 returns to step S54. In other words, the skill determination part 85 repeats steps S54 through S57 until all the predefined intervals have been compared.

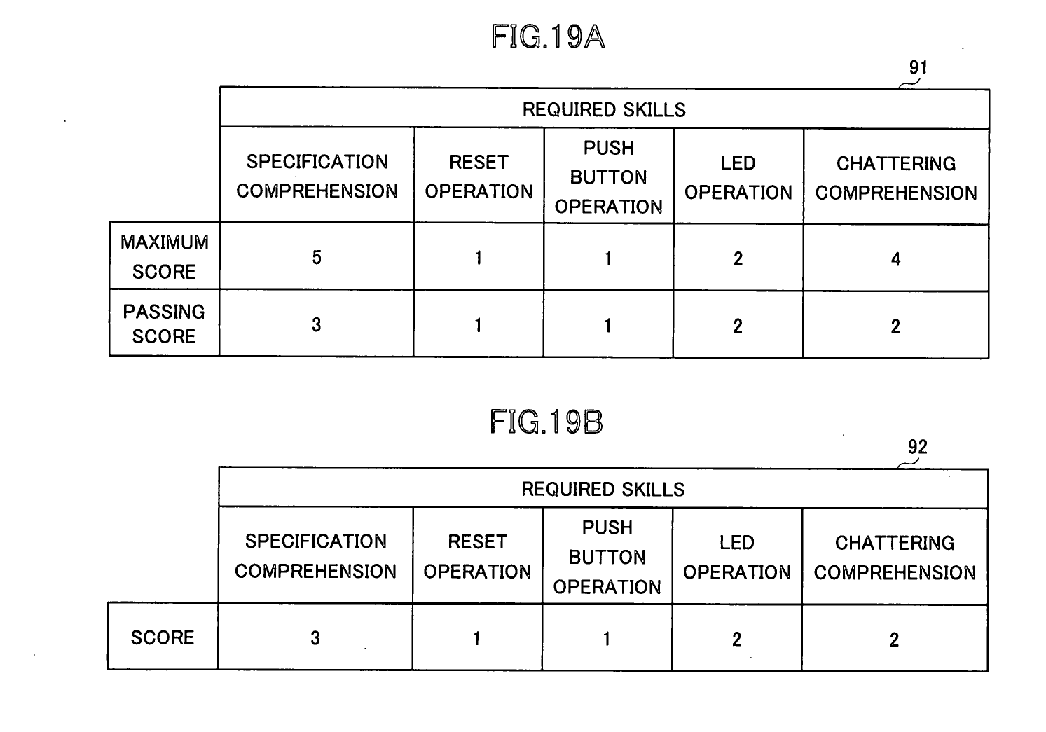

At step S58, the skill determination part 85 reads a passing score table, as illustrated in FIG. 19A, from the passing score table 89.

FIGS. 19A and 19B show exemplary passing score table and score file, respectively, according to the second embodiment.

Referring to FIG. 19, a passing score table 91 represents the maximum score and the passing score for each knowledge item required to make an answer test pattern coincide with a coincidence condition of a predefined interval. A score file 92 represents a score obtained by accumulating weighted points for each required skill at step S56. The score file 92 is obtained from the correct answer test pattern and the answer test pattern shown in FIG. 16 and the score table shown in FIG. 18.

At step S59, the skill determination part 85 compares passing scores of the passing score table 91 to scores of the score file 92 for each required skill, and determines whether scores of all required skills are greater than or equal to passing scores.

If it is determined that the scores of all required skills are greater than or equal to the passing scores (S59: YES), the skill determination part 85 proceeds to step S60 to conduct an acceptance operation. In the acceptance operation at step S60, for example, the skill determination part 85 informs the result report part 86 that the applicant has succeeded.

On the other hand, if scores of all the required skills are not greater than or equal to the passing scores (S59: NO), the skill determination part 85 proceeds to step S61 to conduct a rejection operation. In the rejection operation at step S61, for example, the skill determination part 85 informs the result report part 86 that the applicant has not succeeded, and further reports to the result report part 86 one or more required skills for which the applicant could not obtain the passing scores thereof.

Referring back to FIG. 13, the result report part 86 conducts a result report operation to report the result to the recruitment staff and the applicant at step S47. The result report part 86 informs the recruitment staff that the applicant has succeeded or not succeeded. In addition, if the applicant has not succeeded, the result report part 86 reports one or more required skills for which the applicant could not obtain the passing scores. The result report part 86 may additionally inform the applicant via an e-mail that the applicant has succeeded or not succeeded. Alternatively, the result report part 86 may allow the applicant to confirm the result by using a Web page.

Although the skill determination system 2 according to the second embodiment is configured to allow the skill determination client 70 to make use of the logic simulation part 82 the logic combination part 83, and the logic verification part 84 of the skill determination server 80, the logic simulation part 82, the logic combination part 83 and the logic verification part 84 may be provided to the skill determination client 70.

According to the skill determination system 2 of the second embodiment, it is possible to properly determine one or more skills of an applicant required as a design engineer by obtaining an answer test pattern from a netlist created by the applicant and evaluating knowledge of the applicant based on a comparison result between the answer test pattern and a correct answer test pattern read from a score table.

Specifically, each interval of the answer test pattern and the correct answer test pattern is associated with one or more required skills to make the interval of the answer test pattern coincide with or approximate to the corresponding interval of the correct answer test pattern via a score table. As a result, it is possible to objectively determine the skills required for the applicant to work as a design engineer without much time and cost.

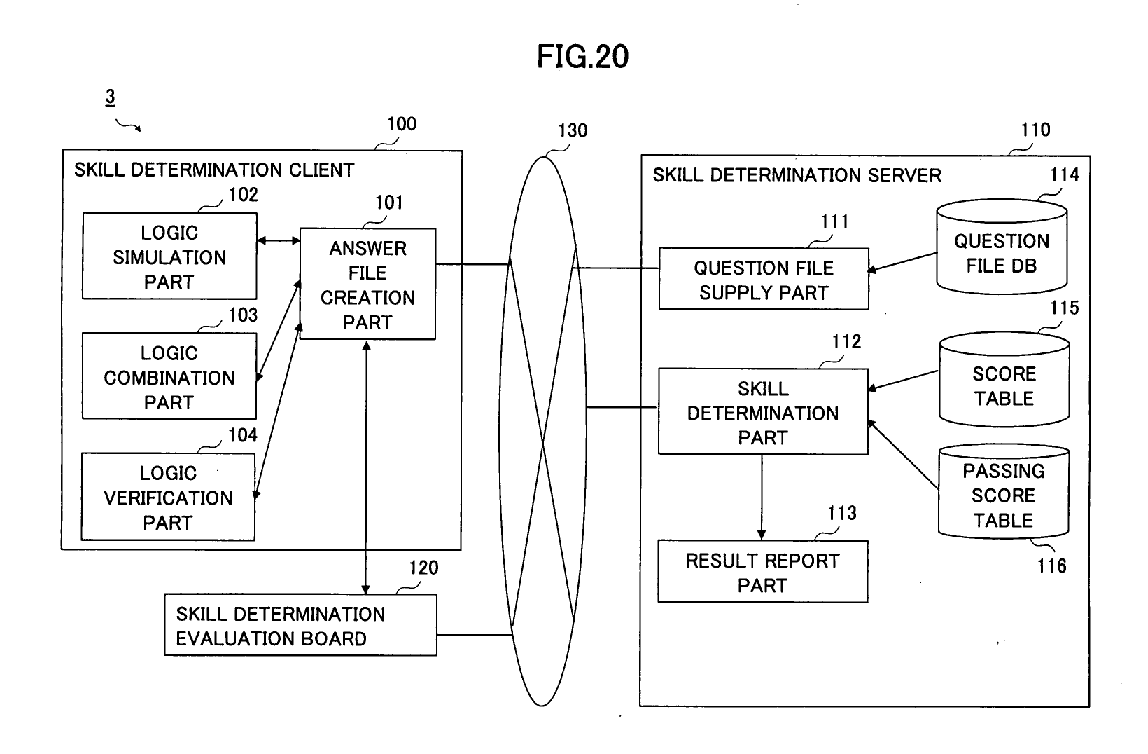

A description is given, with reference to FIG. 20 through FIG. 23, of a skill determination system according to a third embodiment of the present invention.

FIG. 20 is a block diagram illustrating an exemplary structure of a skill determination system according to the third embodiment. A skill determination system 3 according to the third embodiment differs from the above-mentioned skill determination systems 1 and 2 in that a circuit is configured by loading ROM data generated from a netlist in an actual element on a skill determination evaluation board 120 and the operation thereof is checked by using the circuit on the actual element.

The skill determination system 3 partially has the same structure as that of the skill determination system 1 or 2, and the description thereof is omitted. Also, components unnecessary for explaining the third embodiment are omitted in FIG. 20.

Referring to FIG. 20, the skill determination system 3 includes a skill determination client 100 and a skill determination server 110. The skill determination client 100 and the skill determination server 110 are connected to each other via a network 130 such as the Internet and WAN. In addition, the skill determination client 100 is connected to a skill determination evaluation board 120 described in detail below.

The skill determination client 100, which is operated by an applicant, includes an answer file creation part 101, a logic simulation part 102, a logic combination part 103 and a logic verification part 104.

On the other hand, the skill determination server 110, which is used by a recruitment staff, includes a question file supply part 111, a skill determination part 112, a result report part 113, a question file DB 114, a score table 115 and a passing score table 116.

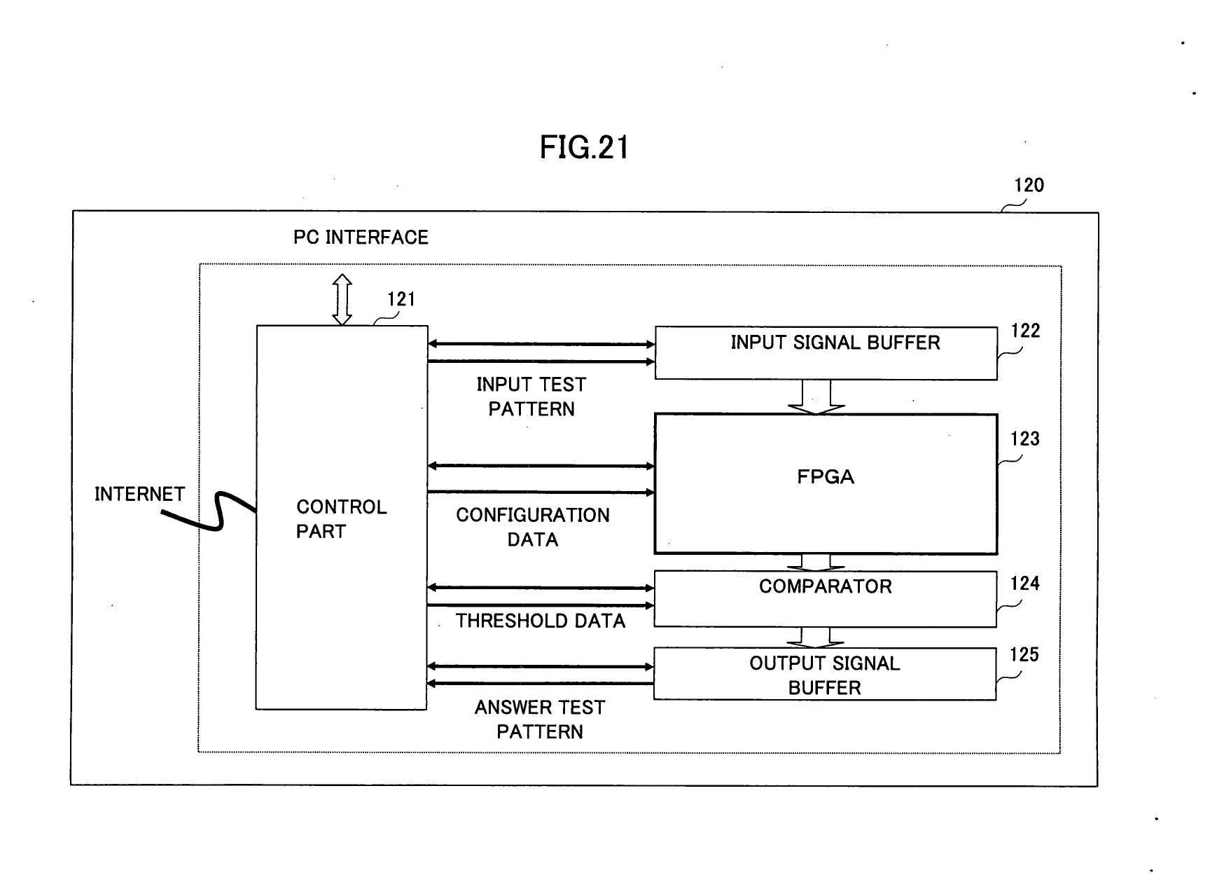

The skill determination evaluation board 120 is configured, for example, as illustrated in FIG. 21.

FIG. 21 is a block diagram illustrating an exemplary structure of the skill determination evaluation board 120 according to the third embodiment.

Referring to FIG. 21, the skill determination evaluation board 120 includes a control part 121, an input signal buffer 122, FPGA (Field Programmable Gate Array) 123, a comparator 124 and an output signal buffer 125.

The control part 121 communicates with the skill determination client 100 via a PC interface (not illustrated). Also, the control part 121 is connected to the Internet, which is an embodiment of the network 130, via an Internet connection part (not illustrated) to communicate with the skill determination server 110. It is noted that the control part 121 may communicate with the skill determination server 110 via the skill determination client 100. In this case, the Internet connection part can be omitted.

The control part 121, in response to receipt of ROM data from the skill determination client 100, loads the ROM data in FPGA 123. Also, the control part 121, in response to receipt of an input test pattern from the skill determination client 100 or the skill determination server 110, supplies the input test pattern to the input signal buffer 122.

Then, the control part 121, in response to receipt of an answer test pattern from the output signal buffer 125, supplies the answer test pattern to the skill determination client 100 or the skill determination server 110.

The control part 121, in response to receipt of threshold data (for example, 1, 0, Hi-Z) to measure an output level of FPGA 123 from the skill determination client 100 or the skill determination server 110, supplies the threshold data to the comparator 124. Also, the control part 121, in response to a request from the skill determination client 100 or the skill determination server 110, controls operations of the input signal buffer 122, the comparator 124 and the output signal buffer 125.

The input signal buffer 122 supplies the input test pattern received from the control part 121 to FPGA 123 at a predefined timing. The comparator 124 compares the answer test pattern supplied from FPGA 123 to the threshold data received from the control part 121, and supplies a comparison result to the output signal buffer 125 at a predefined timing.

The output signal buffer 125 stores the comparison result received from the comparator 124 at a predefined timing, and supplies the comparison result as the answer test pattern to the control part 121.

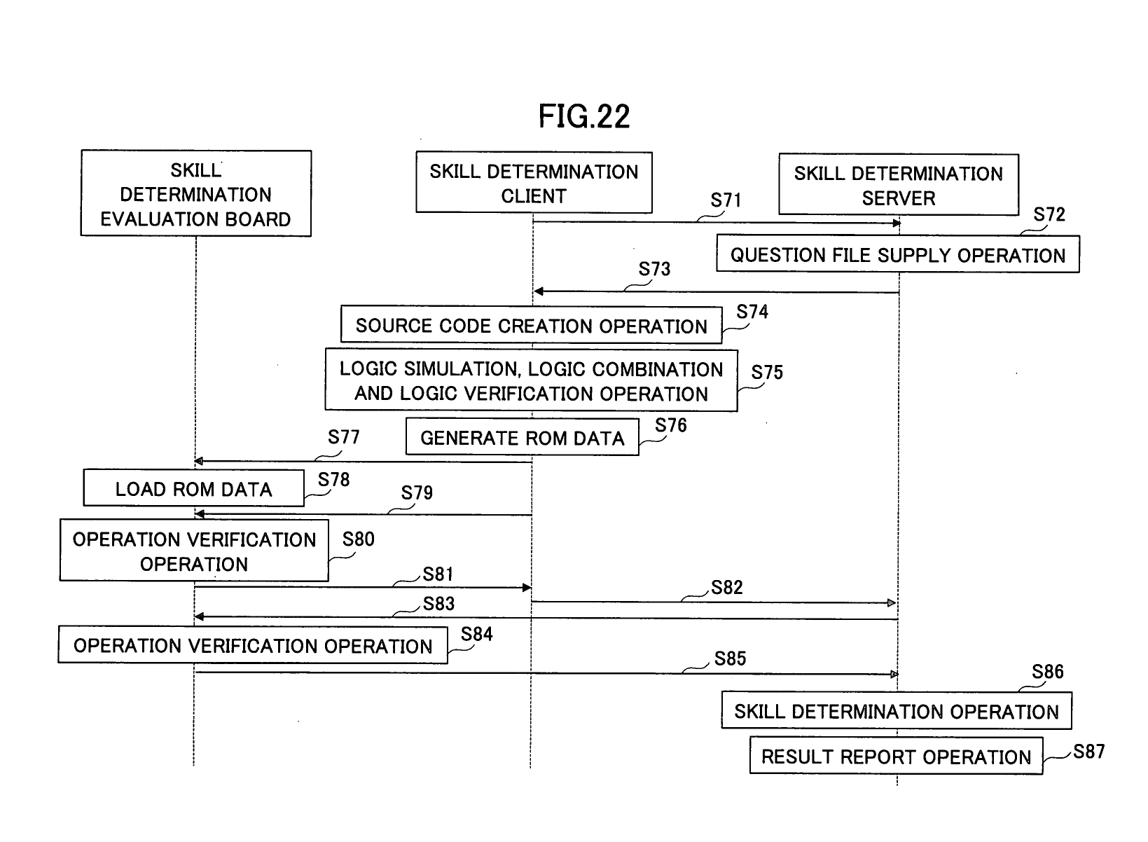

A description is given, with reference to FIG. 22, of an exemplary operation of the skill determination system 3 according to the third embodiment.

FIG. 22 is a sequence diagram of an exemplary operation of the skill determination system 3 according to the third embodiment.

Referring to FIG. 22, the skill determination client 100 logs in the skill determination server 110 through manipulation of an applicant at step S71. The answer file creation part 101 of the skill determination client 100 requests the question file supply part 111 of the skill determination server 110 to send a circuit design specification as a question file. At step S72, the question file supply part 111 of the skill determination server 110 reads a circuit design specification from the question file DB 114.

At step S73, the question file supply part 111 sends the circuit design specification to the answer file creation part 101 of the skill determination client 100. At step S74, the answer file creation part 101 of the skill determination client 100, in response to a request from the applicant, displays the received circuit design specification on the display device 42. The applicant creates a source code representing a circuit corresponding to the circuit design specification in accordance with a hardware description language, an input test pattern and threshold data with reference to the circuit design specification.

At step S75, the answer file creation part 101 of the skill determination client 100, in response to a request from the applicant, uses the logic simulation part 102 to conduct logic simulation on the source code. Also, the answer file creation part 101 of the skill determination client 100, in response to a request from the applicant, uses the logic combination part 103 to generate a netlist from the source code. It is noted that the applicant is instructed to set a design convention and a combination condition to use logic combination of the source code. The answer file creation part 101 of the skill determination client 100, in response to a request from the applicant, uses the logic verification part 104 to conduct logic verification on the generated netlist.

The applicant repeats steps S74 and S75 until the logic verification result meets the circuit design specification at step S75. Here, the answer file creation part 101 displays the logic simulation result or the logic verification result on the display device 42, and thereby the applicant can confirm the logic simulation result or the logic verification result. Also, in this embodiment, the applicant determines whether the logic simulation result or the logic verification result meets the circuit design specification.

At step S76, the answer file creation part 101 of the skill determination client 100, in response to a request from the applicant, generates ROM data (configuration data) from the netlist.

At step S77, the answer file creation part 101 of the skill determination client 100 supplies the generated ROM data to the control part 121 of the skill determination evaluation board 120, and instructs the control part 121 to load the ROM data into FPGA 123. At step S78, the control part 121 loads the ROM data supplied from the skill determination client 100 into FPGA 123.

At step S79, the answer file creation part 101 of the skill determination client 100 supplies the input test pattern and the threshold data created by the applicant to the control part 121. The control part 121, in response to receipt of the input test pattern, supplies the input test pattern to the input signal buffer 122.

At step S80, the control part 121, in response to a request from the skill determination client 100, controls operations of the input signal buffer 122, the comparator 124 and the output signal buffer 125, and verifies the operations.

Specifically, the input signal buffer 122 supplies the input test pattern supplied from the control part 121 to FPGA 123 at a predefined timing. The comparator 124 compares the answer test pattern supplied from FPGA 123 to the threshold data supplied from the control part 121, and supplies a comparison result to the output signal buffer 125 at a predefined timing.

The output signal buffer 125 stores the comparison result supplied from the comparator 124 at a predefined timing, and supplies the comparison result as an answer test pattern to the control part 121. At step S81, the control part 121 supplies the answer test pattern supplied from the output signal buffer 125 to the skill determination client 100.

The applicant repeats steps S74 through S81 until the operation verification result meets the circuit design specification at step S80. Here, the answer file creation part 101 displays the operation verification result on the display device 42, and thereby the applicant can confirm the operation verification result. Also, in this embodiment, the applicant determines whether the operation verification result meets the circuit design specification.

At step S82, the answer file creation part 101 of the skill determination client 100 informs the skill determination part 112 of the skill determination server 110 that answer preparation has been completed.

At step S83, the skill determination part 112 reads an input test pattern corresponding to the circuit design specification from the score table 115. The skill determination part 112 supplies the input test pattern and the threshold data to the control part 121 of the skill determination evaluation board 120.

The control part 121, in response to receipt of the input test pattern from the skill determination server 110, supplies the input test pattern to the input signal buffer 122. At step S84, the control part 121, in response to a request from the skill determination server 110, controls operations of the input signal buffer 122, the comparator 124 and the output signal buffer 125, and verifies the operations.

Specifically, the input signal buffer 122 supplies the input test pattern supplied from the control part 121 to FPGA 123 at predefined timing. The comparator 124 compares the answer test pattern supplied from FPGA 123 to the threshold data supplied from the control part 121, and supplies a comparison result to the output signal buffer 125 at a predefined timing.

The output signal buffer 125 stores the comparison result supplied from the comparator 124 at a predefined timing, and supplies the comparison result as an answer test pattern to the control part 121. At step S85, the control part 121 supplies the answer test pattern supplied from the output signal buffer 125 to the skill determination part 112 of the skill determination server 110.

At step S86, the skill determination part 112 reads a correct answer test pattern corresponding to the circuit design specification from the score table 115. The skill determination part 112 uses the answer test pattern supplied from the skill determination evaluation board 120 and the correct answer test pattern read from the score table 115 to conduct a skill determination operation corresponding to steps S54 through S61 in FIG. 14 and FIG. 15.

At step S87, the result report part 113 conducts a result report operation for the recruitment staff and the applicant. The result report part 113 informs the recruitment staff that the applicant has succeeded or not succeeded. In addition, if the applicant has not succeeded, the result report part 113 informs the recruitment staff of one or more required skills for which the applicant could not obtain passing scores. Here, the result report part 113 may further inform the applicant via an e-mail that the applicant has succeeded or not succeeded. Also, the result report part 113 may allow the applicant to check whether the applicant has succeeded or not succeeded by using a Web page.

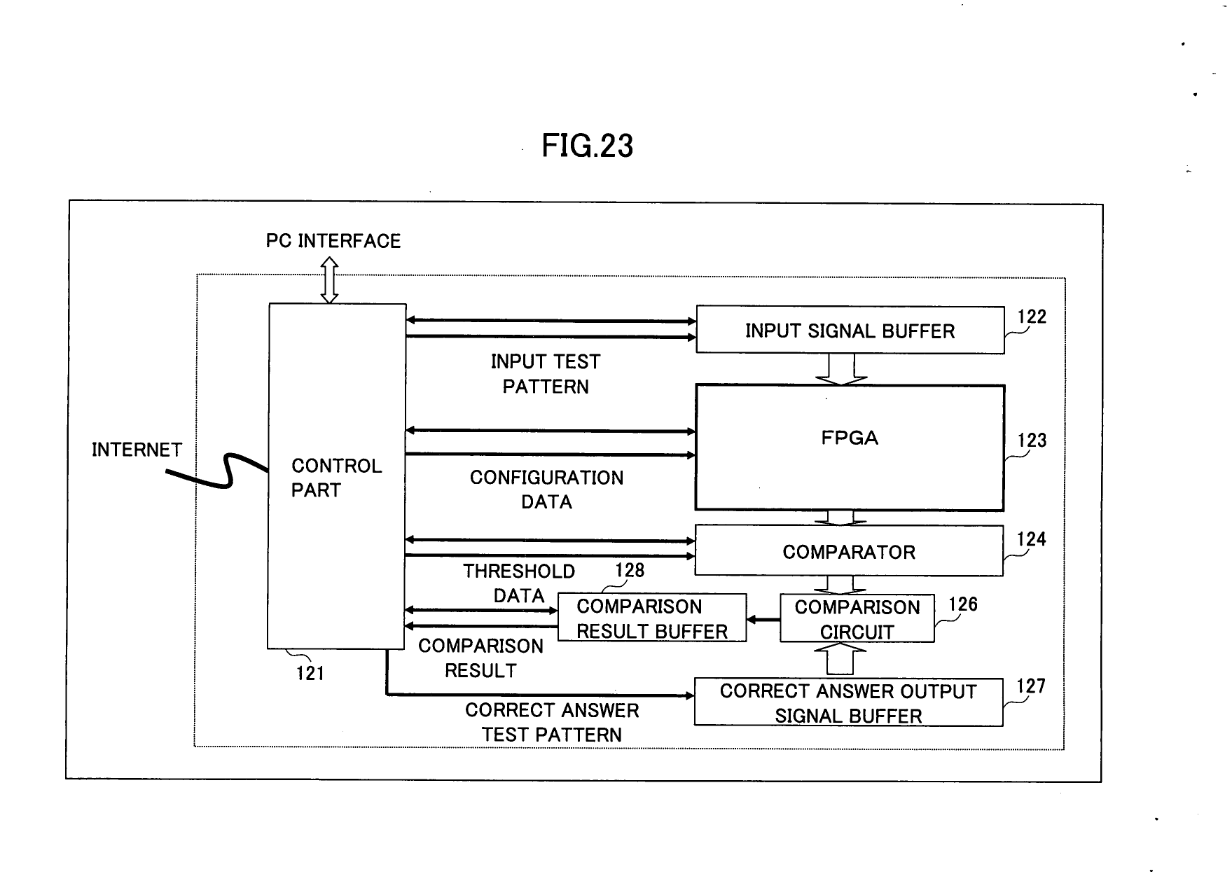

In another embodiment of the present invention, the skill determination evaluation board 120 may be configured, for example, as illustrated in FIG. 23.

FIG. 23 shows another exemplary structure of a skill determination evaluation board according to the third embodiment. In FIG. 23, the illustrated skill determination evaluation board 120 is partially similar to the skill determination evaluation board 120 shown in FIG. 21. Thus, the same components are designated by the same reference numerals, and the description thereof is omitted.

Referring to FIG. 23, the skill determination evaluation board 120 includes a control part 121, an input signal buffer 122, FPGA 123, a comparator 124, a comparison circuit 126, a correct answer output signal buffer 127 and a comparison result buffer 128.

The control part 121, in response to receipt of a correct answer test pattern from the skill determination server 110, supplies the correct answer test pattern to the correct answer output signal buffer 127. Also, the control part 121, in response to receipt of a comparison result between an answer test pattern and a correct answer test pattern from the comparison result buffer 128, supplies a comparison result to the skill determination server 110.

Also, the control part 121, in response to a request from the skill determination client 100 or the skill determination server 110, controls operations of the input signal buffer 122, the comparator 122, the comparison circuit 126, the correct answer output signal buffer 127 and the comparison result buffer 128.

The input signal buffer 122 supplies an input test pattern supplied from the control part 121 to FPGA 123 at a predefined timing. The comparator 124 compares an output signal supplied from FPGA 123 to threshold data supplied from the control part 121, and supplies the comparison result as an answer test pattern to the comparison circuit 126.

The correct answer output signal buffer 127 supplies a correct answer test pattern supplied from the skill determination server to the comparison circuit 126 at a predefined timing. The comparison circuit 126 compares the answer test pattern supplied from the comparator 126 to the correct answer test pattern supplied from the correct answer output signal buffer 127, and supplies a comparison result to the comparison result buffer 128.

The comparison result buffer 128 stores the comparison result supplied from the comparison circuit 126 at a predefined timing, and supplies the comparison result to the control part 121. The control part 121 supplies the comparison result supplied from the comparison result buffer 128 to the skill determination server 110.

A description is given, with reference to FIG. 22, of another exemplary operation of the skill determination system 3 having the skill determination evaluation board 120 shown in FIG. 23 according to the third embodiment. In the operation, steps S71 through S82 are the same as the above-mentioned operation of the skill determination system 3 having the skill determination evaluation board 120 shown in FIG. 21.

At step S83, the skill determination part 112 reads an input test pattern and a correct answer test pattern corresponding to a circuit design specification from the score table 115. The skill determination part 112 supplies the input test pattern and the correct answer test pattern to the control part 121 of the skill determination evaluation board 120.

The control part 121, in response to receipt of the input test pattern from the skill determination server 110, supplies the input test pattern to the input signal buffer 122. The control part 121, in response to receipt of the correct answer test pattern from the skill determination server 110, supplies the correct answer test pattern to the correct answer output signal buffer 127.

At step S84, the control part 121, in response to a request from the skill determination server 110, controls operations of the input signal buffer 122, the comparator 124, the comparison circuit 126, the correct answer output signal buffer 127 and the comparison result buffer 128, and verifies the operations.

Specifically, the input signal buffer 122 supplies the input test pattern supplied from the control part 121 to FPGA 123 at a predefined timing. The comparator 124 compares an output signal supplied from FPGA 123 to threshold data supplied from the control part 121, and supplies a comparison result as an answer test pattern to the comparison circuit 126.

The correct answer output signal buffer 127 supplies the correct answer test pattern supplied from the skill determination server 110 to the comparison circuit 126 at a predefined timing. The comparison circuit 126 compares the answer test pattern supplied from the comparator 126 to the correct answer test pattern supplied from the correct answer output signal buffer 127, and supplies the comparison result to the comparison result buffer 128.

The comparison result buffer 128 stores the comparison result supplied from the comparison circuit 126 at a predefined timing, and supplies the comparison result to the control part 121. At step S85, the control part 121 supplies the comparison result supplied from the comparison result buffer 128 to the skill determination part 112 of the skill determination server 110.

At step S86, the skill determination part 112 uses the comparison result supplied from the skill determination evaluation board 120 to conduct a skill determination operation corresponding to steps S55 through S61 in FIG. 14 and FIG. 15.

At step S87, the result report part 113 conducts a result report operation for a recruitment staff and an applicant. The result report part 113 informs the recruitment staff that the applicant has succeeded or not succeeded. In addition, if the applicant has not succeeded, the result report part 113 informs the recruitment staff of one or more required skills for which the applicant could not obtain passing scores. Here, the result report part 113 may further inform the applicant via an e-mail that the applicant has succeeded or not succeeded. Alternatively, the result report part 113 may allow the applicant to check whether the applicant has succeeded or not succeeded by using a Web page.

In this embodiment, the skill determination client 100 of the skill determination system 3 includes the logic simulation part 102, the logic combination part 103 and the logic verification part 104. In another embodiment, however, the skill determination client 100 may be configured to make use of the logic simulation part 102, the logic combination part 103 and the logic verification part 104 provided in the skill determination server 110. Alternatively, the skill determination part 112 may acquire a design convention and a combination condition set by the applicant from the skill determination client 100, and make use of the acquired design convention and the combination condition for the purpose of skill determination.

According to the skill determination system 3 of the third embodiment, the skill determination system 3, after an applicant is made to conduct operation verification on a netlist created by the applicant by using the skill determination evaluation board 120, can obtain an answer test pattern, evaluate knowledge of the applicant based on comparison between the answer test pattern and a correct answer test pattern read from the score table 115, and determine one or more skills of the applicant in terms of a design engineer.

Specifically, for each interval of the answer test pattern and the correct answer test pattern, the interval is associated with one or more required skills to make the interval of the answer test pattern coincide with or approximate to the interval of the correct answer test pattern. As a result, it is possible to objectively determine the skills required for the applicant as a design engineer without use of much time and cost.

Here, design procedures and some terms of semiconductors in accordance with the above-mentioned hardware description language are described in detail, for example, in Japanese Laid-Open Patent Application No. 2002-318828, and the reference to such description can be useful for further thorough comprehension of the present invention.

Also, although no authentication scheme to authenticate an applicant is disclosed in the skill determination systems 1 through 3, it is possible to prevent fraudulence, such as spoofing, by using a known authentication technologies (for example, biometric authentication) and determine skills of an applicant with high accuracy.

The present invention is not limited to the specifically disclosed embodiments, and variations and modifications may be made without departing from the scope of the present invention.

The present application is based on Japanese priority application No. 2003-116022 filed Apr. 21, 2003, the entire contents of which are hereby incorporated by reference.

What is claimed is:

1. A method of determining one or more skills of a user as a design engineer by using a skill determination server and a skill determination client wherein the skill determination client is operated by the user and is connected to the skill determination server via a network, comprising steps of:
supplying a question file to determine the one or more skills of the user from the skill determination server to the skill determination client;
providing one or more answers to the question file to the skill determination client through input manipulation of the user and supplying an answer file corresponding to the one or more answers from the skill determination client to the skill determination server; and
evaluating knowledge of the user based on a comparison result between the answer file and a correct answer file corresponding to the question file and determining the one or more skills of the user as a design engineer by using the skill determination server.

2. The method as claimed in claim 1, wherein the question file includes a circuit design specification and a source code representing a circuit corresponding to the circuit design specification in a hardware description language and at least partially having one or more empty spaces, and the answer file includes zero or more answers input in the one or more empty spaces in the source code.

3. The method as claimed in claim 2, wherein the correct answer file includes correspondence between one or more correct answers to be input in the one or more empty spaces in the source code and one or more skills required to input the one or more correct answers in the one or more empty spaces.

4. The method as claimed in claim 1, wherein the question file at least includes a circuit design specification, and the answer file includes a source code created by the user and a netlist generated by conducting logic combination on the source code, said source code representing a circuit corresponding to the circuit design specification in a hardware description language.

5. The method as claimed in claim 4, wherein the correct answer file includes correspondence among an input signal to conduct logic verification on a circuit represented by the netlist, an output signal to be output in response to inputting of the input signal in the circuit, and one or more skills required to generate the output signal from the circuit.

6. A method of determining one or more skills of a user as a design engineer by using a skill determination server, a skill determination client and a skill determination evaluation board wherein the skill determination client is operated by the user and is connected to the skill determination server via a network, and the skill determination evaluation board is connected to the skill determination client via an interface, comprising steps of:
supplying a question file to determine the one or more skills of the user from the skill determination server to the skill determination client;
providing one or more answers to the question file to the skill determination client through input manipulation of the user and supplying an answer file corresponding to the one or more answers from the skill determination client to the skill determination evaluation board;
configuring a circuit corresponding to the answer file on an actual element by using the skill determination evaluation board;
supplying an input signal to conduct logic verification on the circuit from the skill determination server to the skill determination evaluation board and supplying an answer output signal generated from the circuit in response to inputting of the input signal in the circuit from the skill determination evaluation board to the skill determination server; and
evaluating knowledge of the user based on a comparison result between a correct answer output signal to be output in response to inputting of the input signal in the circuit and the supplied answer output signal and determining the one or more skills of the user as a design engineer by using the skill determination server.

7. The method as claimed in claim 6, wherein the question file at least includes a circuit design specification, and the answer file at least includes a netlist generated by conducting logic combination on a source code created by the user, said source code representing a circuit corresponding to the circuit design specification in a hardware description language.

8. The method as claimed in claim 7, wherein the correct answer output signal includes correspondence among an input signal to conduct logic verification on the circuit, an output signal to be output in response to inputting of the input signal in the circuit, and one or more skills required to generate the output signal from the circuit.

9. A method of determining one or more skills of a user as a design engineer by using a skill determination server, a skill determination client and a skill determination evaluation board wherein the skill determination client is operated by the user and is connected to the skill determination server via a network, and the skill determination evaluation board is connected to the skill determination client via an interface, comprising steps of:
supplying a question file to determine the one or more skills of the user from the skill determination server to the skill determination client;
providing one or more answers to the question file to the skill determination client through input manipulation of the user and supplying an answer file corresponding to the one or more answers from the skill determination client to the skill determination evaluation board;
configuring a circuit corresponding to the answer file on an actual element by using the skill determination evaluation board;
supplying an input signal to conduct logic verification on the circuit and a correct answer output signal to be output in response to inputting of the input signal in the circuit from the skill determination server to the skill determination evaluation board and supplying a comparison result between the correct answer output signal to be output in response to inputting of the input signal in the circuit and an answer output signal generated from the circuit from the skill determination evaluation board to the skill determination server; and
evaluating knowledge of the user based on the comparison result supplied from the skill determination evaluation board and determining the one or more skills of the user as a design engineer by using the skill determination server.

10. The method as claimed in claim 9, wherein the question file at least includes a circuit design specification, and the answer file at least includes a netlist generated from a source code created by the user, said source code representing a circuit corresponding to the circuit design specification in a hardware description language.

11. The method as claimed in claim 10, wherein the correct answer output signal includes correspondence among an input signal to conduct logic verification on the circuit, an output signal to be output in response to inputting of the input signal in the circuit, and one or more skills required to generate the output signal from the circuit.

12. A skill determination system for determining one or more skills of a user, comprising:
a skill determination server; and
a skill determination client being connected to the skill determination server via a network,
wherein
the skill determination client, in response to receipt of a question file to determine the one or more skills of the user as a design engineer from the skill determination server and one or more answers to the question file from the user, supplies an answer file corresponding to the one or more answers to the skill determination server; and
the skill determination server, in response to receipt of the answer file from the skill determination client, evaluates knowledge of the user based on a comparison result between the answer file and a correct answer file corresponding to the question file and determines the one or more skills of the user as a design engineer.

13. A skill determination system for determining one or more skills of a user, comprising:
a skill determination server;
a skill determination client being connected to the skill determination server via a network; and
a skill determination evaluation board being connected to the skill determination client via an interface,
wherein
the skill determination client, in response to receipt of a question file to determine the one or more skills of the user as a design engineer from the skill determination server and one or more answers to the question file from the user, supplies an answer file corresponding to the one or more answers to the skill determination evaluation board;
the skill determination evaluation board, in response to receipt of the answer file from the skill determination client, configures a circuit corresponding to the answer file on an actual element, and in response to receipt of an input signal to conduct logic verification on the circuit from the skill determination server, supplies an answer output signal generated from the circuit in response to inputting of the input signal in the circuit to the skill determination server; and
the skill determination server, in response to receipt of the answer output signal from the skill determination evaluation board, evaluates knowledge of the user based on a comparison result between the supplied answer output signal and a correct answer output signal to be output in response to inputting of the input signal in the circuit and determines the one or more skills of the user as a design engineer.

14. A skill determination system for determining one or more skills of a user, comprising:
a skill determination server;
a skill determination client being connected to the skill determination server via a network; and
a skill determination evaluation board being connected to the skill determination client via an interface,
wherein
the skill determination client, in response to receipt of a question file to determine the one or more skills of the user as a design engineer from the skill determination server and one or more answers to the question file from the user, supplies an answer file corresponding to the one or more answers to the skill determination evaluation board;
the skill determination evaluation board, in response to receipt of the answer file from the skill determination client, configures a circuit corresponding to the answer file on an actual element, and in response to receipt of an input signal to conduct logic verification on the circuit and a correct answer output signal to be output in response to inputting of the input signal in the circuit from the skill determination server, supplies a comparison result between the correct answer output signal and an answer output signal generated from the circuit to the skill determination server; and
the skill determination server, in response to receipt of the comparison result from the skill determination evaluation board, evaluates knowledge of the user based on the supplied comparison result and determines the one or more skills of the user as a design engineer.

15. A skill determination server for determining one or more skills of a user manipulating a skill determination client as a design engineer, comprising:
a question file supply part supplying a question file to determine the one or more skills of the user to the skill determination client; and
a skill determination part, in response to receipt of an answer file corresponding to one or more answers to the question file from the skill determination client, evaluating knowledge of the user based on a comparison result between the answer file and a correct answer file corresponding to the question file and determining the one or more skills of the user as a design engineer.

16. A skill determination server for determining one or more skills of a user manipulating a skill determination client as a design engineer, comprising:
a question file supply part supplying a question file to determine the one or more skills of the user to the skill determination client;
an input signal supply part supplying an input signal to conduct logic verification on a circuit configured on an actual element to a skill determination evaluation board connected to the skill determination client via an interface; and
a skill determination part, in response to receipt of an answer output signal generated from the circuit in response to inputting of the input signal in the circuit from the skill determination evaluation board, evaluating knowledge of the user based on a comparison result between the supplied answer output signal and a correct answer output signal to be output in response to the inputting of the input signal in the circuit and determining the one or more skills of the user as a design engineer.

17. A skill determination server for determining one or more skills of a user manipulating a skill determination client as a design engineer, comprising:
a question file supply part supplying a question file to determine the one or more skills of the user to the skill determination client;
an input and output signal supply part supplying an input signal to conduct logic verification on a circuit configured on an actual element and a correct answer output signal to be output in response to inputting of the input signal in the circuit to a skill determination evaluation board connected to the skill determination client via an interface; and
a skill determination part, in response to receipt of a comparison result between the correct answer output signal and an answer output signal generated from the circuit in response to inputting of the input signal in the circuit from the skill determination evaluation board, evaluating knowledge of the user based on the comparison result and determining the one or more skills of the user as a design engineer.

18. A skill determination client for a skill determination system having a skill determination server, the skill determination client connected to the skill determination server via a network, and a skill determination evaluation board connected to the skill determination client via an interface, comprising:
an interface part being configured to connect to the skill determination evaluation board; and
an answer file supply part, in response to receipt of a question file to determine one or more skills of a user as a design engineer from the skill determination server and one or more answers to the question file from the user, supplying an answer file corresponding to the one or more answers to the skill determination evaluation board.

19. A skill determination evaluation board for a skill determination system having a skill determination server, a skill determination client connected to the skill determination server via a network, and the skill determination evaluation board connected to the skill determination client via an interface, comprising:
a circuit generation part, in response to receipt of an answer file corresponding to one or more answers to a question file from the skill determination client, generating a circuit corresponding to the answer file on an actual element;
an input signal buffer temporarily storing an input signal to conduct logic verification on the circuit supplied from the skill determination server and supplying the input signal to the circuit at a predefined timing; and
an output signal buffer temporarily storing an answer output signal generated from the circuit in response to inputting of the input signal in the circuit and supplying the answer output signal to the skill determination server.

20. A skill determination evaluation board for a skill determination system having a skill determination server, a skill determination client connected to the skill determination server via a network, and the skill determination evaluation board connected to the skill determination client via an interface, comprising:
a circuit generation part, in response to receipt of an answer file corresponding to one or more answers to a question file from the skill determination client, generating a circuit corresponding to the answer file on an actual circuit;
an input signal buffer temporarily storing an input signal to conduct logic verification on the circuit supplied from the skill determination server and supplying the input signal to the circuit at a predefined timing;
a comparison part obtaining an answer output signal generated from the circuit in response to inputting of the input signal in the circuit and comparing the answer output signal to a correct answer output signal to be output in response to the inputting of the input signal in the circuit;
an output signal buffer, in response to receipt of the correct answer output signal from the skill determination server, temporarily storing the correct answer output signal and supplying the correct answer output signal to the comparison part; and
a comparison result buffer temporarily storing a comparison result supplied from the comparison part and supplying the comparison result to the skill determination server.
